(19) United States
(12) Patent Application Publication
(10) Pub. No.: US 2007/0223348 A1
(43) Pub. Date: Sep. 27, 2007

(54) Optical recording method, optical recording apparatus and optical recording medium

(75) Inventor: Toshio Sasaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,061

(22) Filed: Mar. 23, 2007

(30) Foreign Application Priority Data
Mar. 24, 2006 (JP) 2006-084131

(51) Int. Cl. G11B 7/00

(52) U.S. Cl. 369/103

(57) ABSTRACT

To provide an optical recording method including: applying information and reference beams onto an optical recording medium to record information therein, the optical recording medium having a recording layer for recording the information by holography, wherein at least the information beam is passed through a spatial light modulator and is formed as a two-dimensional pattern composed of a data area and a plurality of synchronization marks for detecting information concerning the positions of data recorded in the data area, and wherein the synchronization marks are arranged in a random pattern so that in a Fourier-transformed image of the two-dimensional pattern, light intensities derived from the synchronization marks are lower than light intensities in a Fourier-transformed image of a two-dimensional pattern composed of a data area and a plurality of synchronization marks arranged in a grid pattern, the light intensities being derived from the synchronization marks arranged in a grid pattern.

### BACKGROUND OF THE INVENTION

1. Field of the Invention

The present invention relates to an optical recording method for recording information by holography, an optical recording apparatus and an optical recording medium. More specifically, the present invention relates to an optical recording method, an optical recording apparatus and an optical recording medium that are capable of high-multiplexing recording and of recording with less noise occurrence upon reproduction of information and that excel in high-speed digital data processing.

2. Description of the Related Art

An example of a proposed optical recording medium utilizing holography is an optical recording medium 20 shown in FIG. 10, wherein servo pit patterns 3 are formed over a surface of a second substrate 1, a reflective layer 2 made of aluminum or the like is formed on the servo pit patterns 3, a recording layer 4a is formed on the reflective layer 2, and a first substrate 5 is formed on the recording layer 4a.

Moreover, as shown in FIG. 11, a gap layer 8a for smoothing the surface of the second substrate 1 and for adjusting the size of the holograms created in the recording layer 4a, a filter layer 6 that selectively reflects information and reference beams to be described later, and a quarter wavelength plate 9 are disposed between the second substrate 1 and recording layer 4a, in order to improve the performance of the optical recording medium 20a for efficient recording by means of information and reference beams.

An optical recording method for recording information on an optical recording medium by holography generally utilizes optical interference between a reference beam and an information beam (object beam) inside the medium to thereby produce an interference image (interference fringes) that are subsequently recorded therein. As the optical recording method, for example, a method is used in which information and reference beams are applied in such a way that the optical axis of the information beam is collinear with that of the reference beam, a technology that is referred to as the “collinear technology,” wherein interference fringes are created in the recording layer of a medium by application of the information and reference beams, thereby recording optical information in the recording layer. Reproduction of the recorded optical information is performed by applying another identical reference beam to the optical recording medium from the same direction. In this way diffracted rays are created from the interference image and the optical information is reproduced by collecting them.

As a method for increasing the storage capacity of optical recording media, there is proposed a multiplexing recording method for increasing the density of the interference images recorded. More specifically, the shift-multiplexing recording, angle-multiplexing recording, wavelength-multiplexing recording, and phase-multiplexing recording are utilized.

Among these recording methods, the shift-multiplexing recording has high compatibility with conventional CD and DVD recording methods where information is recorded on a spinning disc, and offers high random access performance. This is because in this recording method, additional information, or interference image, is placed one after another on the initial recorded information (the initial interference image) while slightly moving either a beam spot or an optical recording medium along the surface of the recording layer in a relative manner. For this reason, the shift-multiplexing recording is adopted for the collinear technology that uses a single lens for recording (see Japanese Patent Application Laid-Open (JP-A) Nos. 2004-177958 and 2002-40908 and Nikkei Electronics (p 105-114) issued Jan. 17, 2005).

As shown in FIG. 9, the collinear technology-based shift-multiplexing recording records information on a beam spot-by-beam spot basis using an information beam spot 33 obtained by passing the information beam through the objective lens 12 and focusing it onto a recording portion of the recording layer to form a beam spot of certain size. Once one information beam spot 33 has been recorded, the optical recording medium 21 rotates clockwise by one pitch, a direction opposite to the arrow of FIG. 9, followed by irradiation of that beam spot 33 with an information beam for multiplexing recording.

As shown in FIG. 1, the information beam spot 33 is a spot formed by passing of an information beam through a spatial light modulator and has a page data pattern consisting of an array of 4,000 pixels defined by vertical and horizontal lines. In FIG. 1, the page data pattern is formed of a data area 34 consisting of solid pixels and synchronization marks 35 formed of blank pixels. Each of the synchronization marks 35 serve as a mark for the identification of digital data recorded in the data area 34, and stores positional information based on which digital data in the information beam spot 33 are identified.

When the synchronization marks 35 are detected upon reproduction of information, the positions of digital data are determined on the basis of the positions of the synchronization marks 35, whereby the positions of all of the digital data in the information beam spot 33 can be recognized and the digital data are reproduced as a single page data.

As shown in FIG. 1, these synchronization marks 35 are generally arranged in a grid pattern in view of the easiness with which the positions of digital data are identified upon reproduction of information.

In particular, in a case of optical recording methods wherein interference fringes that resulted by optical interference between the information and reference beams are recorded as in collinear technology-based methods, the light intensity distribution of the beam of light in the vicinity of the beam focusing area of the optical recording medium appears as a Fourier-transformed image of the grid pattern. When the synchronization marks 35 are arranged in a grid pattern, it results in light intensity convergence at specific positions according to that pattern as shown in the light intensity distribution of the Fourier-transformed image shown in FIG. 20, resulting in high light intensities for recording compared to other recording areas.

When the light intensity increases at specific positions, it results in consumption of a large amount of such photosensitive materials as a photoinitiator and/or monomers in the recording layer at positions corresponding to those specific positions, and thus the recording sensitivities of areas near the specific positions undesirably decrease. Moreover, when shift-multiplex recording is performed, cycles of this site-specific high-light intensity recording are repeated, leading to generation of diffraction noise upon information reproduction.

Meanwhile, an optical recording method is known in which synchronization marks are formed as a tracking element pattern consisting of a plurality of pixels, and the tracking element pattern is used as reference positional information (see JP-A No. 2005-50522).

The tracking element pattern, however, is a combination of data consisting of a set of “0s” and “1s” as with digital data recorded in the data area and hence is recognized as error data, which is used as reference positional information. Thus, it is troublesome to distinguish data recorded in the data area over data recorded as synchronization marks. For this reason, the tracking element pattern cannot achieve high-speed data processing.

The current situation is, therefore, that no optical recording method, optical recording apparatus and optical recording medium have been provided that are capable of increasing the cycles of collinear technology-based shift-multiplexing recording and of recording with less noise occurrence upon reproduction of information and that excel in high-speed digital data processing; it is desired that they will be provided.

### BRIEF SUMMARY OF THE INVENTION

It is an object of the present invention to solve the foregoing problems in the art and to achieve the object described below. That is, an object of the present invention is to provide an optical recording method, an optical recording apparatus and an optical recording medium that are capable of high-multiplexing recording and of recording with less noise occurrence upon reproduction of information and that excel in high-speed digital data processing.

The optical recording method of the present invention includes: applying an information beam and a reference beam onto an optical recording medium to record information therein, the optical recording medium having a recording layer for recording the information by holography, wherein at least the information beam is passed through a spatial light modulator and is formed as a two-dimensional pattern that is composed of a data area and a plurality of synchronization marks for detecting information concerning the positions of data recorded in the data area, and wherein the synchronization marks are arranged in a random pattern so that in a Fourier-transformed image of the two-dimensional pattern, light intensities derived from the synchronization marks are lower than light intensities in a Fourier-transformed image of a two-dimensional pattern composed of a data area and a plurality of synchronization marks arranged in a grid pattern, the light intensities being derived from the synchronization marks arranged in a grid pattern.

The optical recording apparatus of the present invention includes a laser light source for emitting an information beam and a reference beam onto an optical recording medium to record information therein, the optical recording medium having a recording layer for recording the information by holography; and a spatial light modulator through which at least one of the information beam and reference beam passes, wherein the information beam passed through the spatial light modulator is formed as a two-dimensional pattern that is composed of a data area and a plurality of synchronization marks for detecting information concerning the positions of data recorded in the data area, and wherein the synchronization marks are arranged in a random pattern so that in a Fourier-transformed image of the two-dimensional pattern, light intensities derived from the synchronization marks are lower than light intensities in a Fourier-transformed image of a two-dimensional pattern composed of a data area and a plurality of synchronization marks arranged in a grid pattern, the light intensities being derived from the synchronization marks arranged in a grid pattern.

The optical recording medium of the present invention records information therein with the optical recording method of the present invention.

The optical reproduction method used in the present invention applies onto an interference image a reproduction beam that is identical to a reference beam, the interference image being recorded in the recording layer by the optical recording method of the present invention, thereby reproducing recorded information corresponding to that interference image.

The method for manufacturing the optical recording medium of the present invention includes a filter layer formation step wherein a filter designed for optical recording media is cut into an optical recording media shape, followed by bonding of that filter to the second substrate to form a filter layer.

According to the present invention, it is possible to provide an optical recording method, an optical recording apparatus and an optical recording medium that are capable of high-multiplexing recording and of recording with less noise occurrence upon reproduction of information and that excel in high-speed digital data processing.

### BRIEF DESCRIPTION OF THE SEVERAL VIEWS OF THE DRAWINGS

FIG. 1 is a conceptual diagram showing a pattern of synchronization marks of a conventional information beam passed through a spatial light modulator, the synchronization marks being arranged in a grid pattern.

FIG. 2 is a conceptual diagram showing a pattern of synchronization marks of an information beam in the present invention passed through a spatial light modulator, the synchronization marks being arranged in a random pattern.

FIG. 3 is a conceptual diagram showing a pattern of synchronization marks of an information beam in the present invention passed through a spatial light modulator, the synchronization marks being arranged in a solid cross.

FIG. 4 is a conceptual diagram showing a pattern of synchronization marks of an information beam in the present invention passed through a spatial light modulator, the synchronization marks being arranged in a dotted cross.

FIG. 5 is a conceptual diagram showing a pattern of synchronization marks of an information beam in the present invention passed through a spatial light modulator, the synchronization marks being arranged in a zigzag cross.

FIG. 6 is a conceptual diagram showing a pattern of synchronization marks of an information beam in the present invention passed through a spatial light modulator, the synchronization marks being arranged in a corrugated cross.

FIG. 7 is a conceptual diagram showing a pattern of synchronization marks of an information beam in the present invention passed through a spatial light modulator, the synchronization marks being arranged in a solid line which encompasses the entire circumference of a data area.

FIG. 8 is a conceptual diagram showing a pattern of synchronization marks of an information beam in the present invention passed through a spatial light modulator, the synchronization marks being arranged in a dotted line which encompasses the entire circumference of a data area.

FIG. 9 is a perspective diagram conceptually showing performing shift-multiplexing recording on an optical recording medium using the information beam and the reference beam in the present invention.

FIG. 10 is a schematic cross-sectional view of a conventional optical recording medium.

FIG. 11 is another schematic cross-sectional view of a conventional optical recording medium.

FIG. 12 is a partial schematic cross-sectional view showing the structure of the optical recording medium of the present invention.

FIG. 13 is an exploded perspective view showing an example of the layer configuration of the optical recording medium of the present invention.

FIG. 14 is a schematic cross-sectional view showing an example of the structure of an optical recording medium according to Specific Example 1.

FIG. 15 is a schematic cross-sectional view showing an example of the structure of an optical recording medium according to Specific Example 2.

FIG. 16 is a graph showing reflection characteristics of a filter, which is a laminate of three cholesteric liquid crystal layers, for incident light from the vertical direction (0°).

FIG. 17 is an explanatory diagram showing an example of optical systems according to the present invention around an optical recording medium.

FIG. 18 is a block diagram showing an example of an entire configuration of the optical recording apparatus of the present invention.

FIG. 19 is a conceptual diagram showing a specific example of a pattern of a conventional information beam passed through a spatial light modulator, the synchronization marks being arranged in a grid pattern.

FIG. 20 is a conceptual diagram showing a specific example of a Fourier-transformed image of a conventional information beam passed through a spatial light modulator, the image having synchronization marks arranged in a grid pattern.

FIG. 21 is a conceptual diagram showing a specific example of a pattern of synchronization marks of an information beam in the present invention passed through a spatial light modulator, the synchronization marks being arranged in a random pattern.

FIG. 22 is a conceptual diagram showing a specific example of a Fourier-transformed image of an information beam in the present invention passed through a spatial light modulator, the image having synchronization marks arranged in a random pattern.

FIG. 23 is a conceptual diagram showing a specific example of a pattern of synchronization marks of an information beam in the present invention passed through a spatial light modulator, the synchronization marks being arranged in a solid cross.

FIG. 24 is a conceptual diagram showing a specific example of a Fourier-transformed image of an information beam in the present invention passed through a spatial light modulator, the image having synchronization marks arranged in a solid cross.

FIG. 25 is a conceptual diagram showing a specific example of a pattern of synchronization marks of the information beam in the present invention passed through a spatial light modulator, the synchronization marks being arranged in a dotted cross.

FIG. 26 is a conceptual diagram showing a specific example of a Fourier-transformed image of an information beam in the present invention passed through a spatial light modulator, the image having synchronization marks arranged in a dotted cross.

FIG. 27 is a conceptual diagram showing a specific example of a pattern of synchronization marks of an information beam in the present invention passed through a spatial light modulator, the synchronization marks being arranged in a solid line which encompasses the entire circumference of a data area.

FIG. 28 is a conceptual diagram showing a specific example of a Fourier-transformed image of an information beam in the present invention passed through a spatial light modulator, the image having synchronization marks arranged in a solid line which encompasses the entire circumference of a data area.

FIG. 29 is a conceptual diagram showing a specific example of a pattern of an information beam in the present invention passed through a spatial light modulator, the synchronization marks being arranged in a dotted line which encompasses the entire circumference of a data area.

FIG. 30 is a conceptual diagram showing a specific example of a Fourier-transformed image of an information beam in the present invention passed through a spatial light modulator, the image having synchronization marks arranged in a dotted line which encompasses the entire circumference of a data area.

### DETAILED DESCRIPTION OF THE INVENTION

### (Optical Recording Method)

The optical recording method of the present invention is an optical recording method for recording information in an optical recording medium by application of information and reference beams thereto, wherein the optical recording medium includes a recording layer in which information is recorded by holography, and wherein a beam spot of at least one of the information and reference beams is formed as a two-dimensional pattern by spatial light modulating, which the pattern consisting of a data area and a plurality of synchronization marks for identifying the positions of data recorded in the data area, and the synchronization marks are randomly arranged so that light intensities in a Fourier-transformed image of that pattern that are derived from the synchronization marks are lower than light intensities in a Fourier-transformed image of a pattern consisting of a data area and a plurality of synchronization marks arranged in a grid pattern, the light intensities being derived the synchronization marks arranged in a grid pattern. Moreover, where necessary, the optical recording method of the present invention includes additional step(s) selected appropriately. It is preferable that the optical recording method of the present invention be used with the collinear technology wherein information and reference beams are applied so that the optical axis of the information beam is collinear with that of the reference beam.

### <Information Beam and Reference Beam>

The information beam and reference beam are not particularly limited and can be appropriately selected depending on the intended purpose. For example, a coherent laser beam emitted from a light source is preferably used.

The laser beam is not particularly limited, and laser beams that have the capability to emit one or more wavelengths of 360 nm to 850 nm are suitable used. The wavelength is preferably 380 nm to 800 nm, more preferably 400 nm to 750 nm, most preferably 500 nm to 600 nm where the center of the visual region is most visible.

A wavelength of less than 360 nm may result in difficulty in designing an optical system, whereas a wavelength of greater than 850 nm may result in reduced storage capacity.

The light source of the laser beams is not particularly limited and can be appropriately selected depending on the intended purpose. For example, a solid-state laser oscillator, semiconductor laser oscillator, liquid-state laser oscillator, or gas-state laser oscillator can be used. Among these, a gas-state laser oscillator or semiconductor laser oscillator can be suitably used.

The method for applying the information beam and reference beam is not particularly limited and can be appropriately selected depending on the intended purpose. For example, a laser beam from one light source may be split into the information beam and reference beam. Alternatively two laser beams emitted from different light sources may be used as the information beam and reference beam.

The direction in which the information beam and reference beam are applied, or the angle at which they are incident, is not particularly limited and can be appropriately determined depending on the intended purpose. For example, the information beam and reference beam may be applied from different directions, or may be applied from the same direction. Alternatively, they may be applied in such a way that the optical axis of the information beam is collinear with that of the reference beam.

In the optical recording medium optical interference is allowed to take place between the information (object) beam and reference beam, creating interference fringes that are subsequently written in the medium. In this way information is recorded in the medium.

In the case of a collinear technology-based recording method, the data to be recorded is processed into digital data on a beam spot-by beam spot basis, each of the beam spots having data (about 4,000 bits) in the form of a page data pattern, and is converted by a Spatial Light Modulator (SLM) into pixels, a minimum unit of the page data pattern. Through this processing, the data to be recorded are converted into digital data represented by a set of “0s” and “1s.”

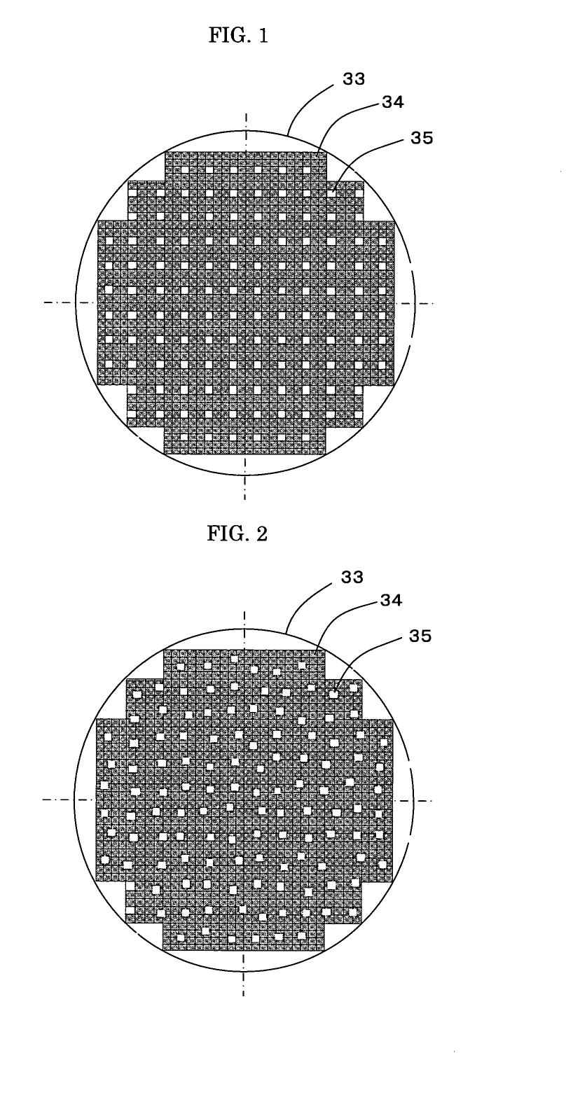

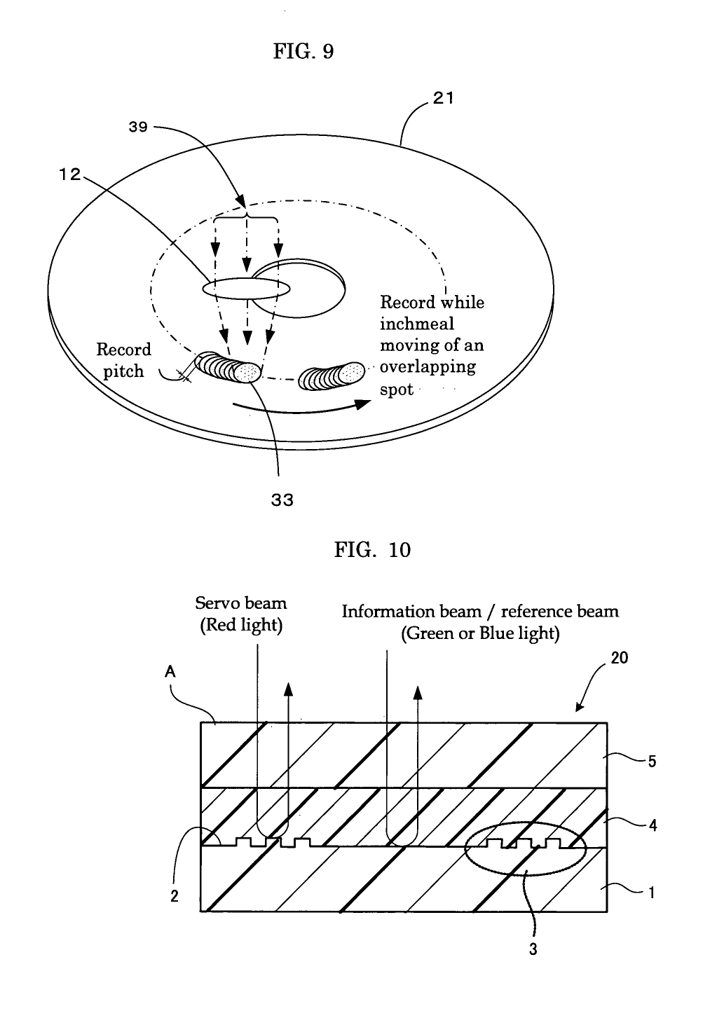

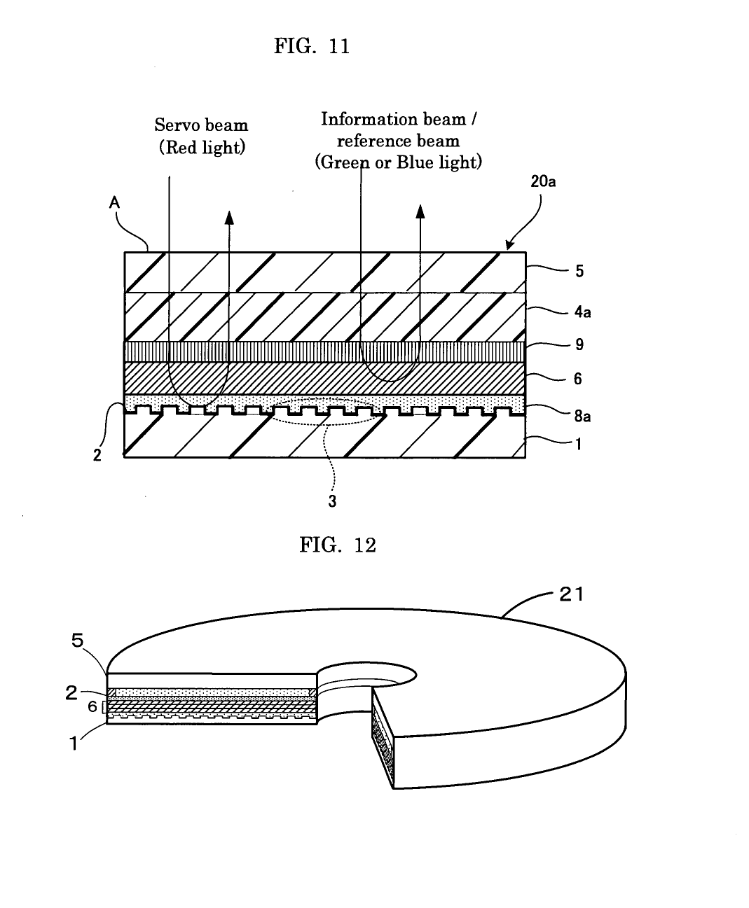

As shown in FIG. 9, the information beam consisting of digital data passes through the objective lens 12 and is focused onto a recording portion of the recording layer of the optical recording medium 21, forming a beam spot of certain size. More specifically, in the case of a collinear technology-based optical recording method, the information beam is focused to form an information beam spot 33 of about 200 μm in diameter, and subsequent application of a reference beam onto the spot creates interference fringes to be recorded in the recording layer. As shown in FIG. 1, the information beam spot 33 is formed of a page data pattern consisting of an array of multiple pixels defined by vertical and horizontal lines using a spatial light modulator. In FIG. 1, the page data pattern is formed of a data area consisting of solid pixels and synchronization marks 35 formed of blank pixels. The size of each pixel is dependent on the pixel size of a spatial light modular to be adopted; for example, each pixel consists of sub-pixels, each of which measures 13 μm by 13 μm.

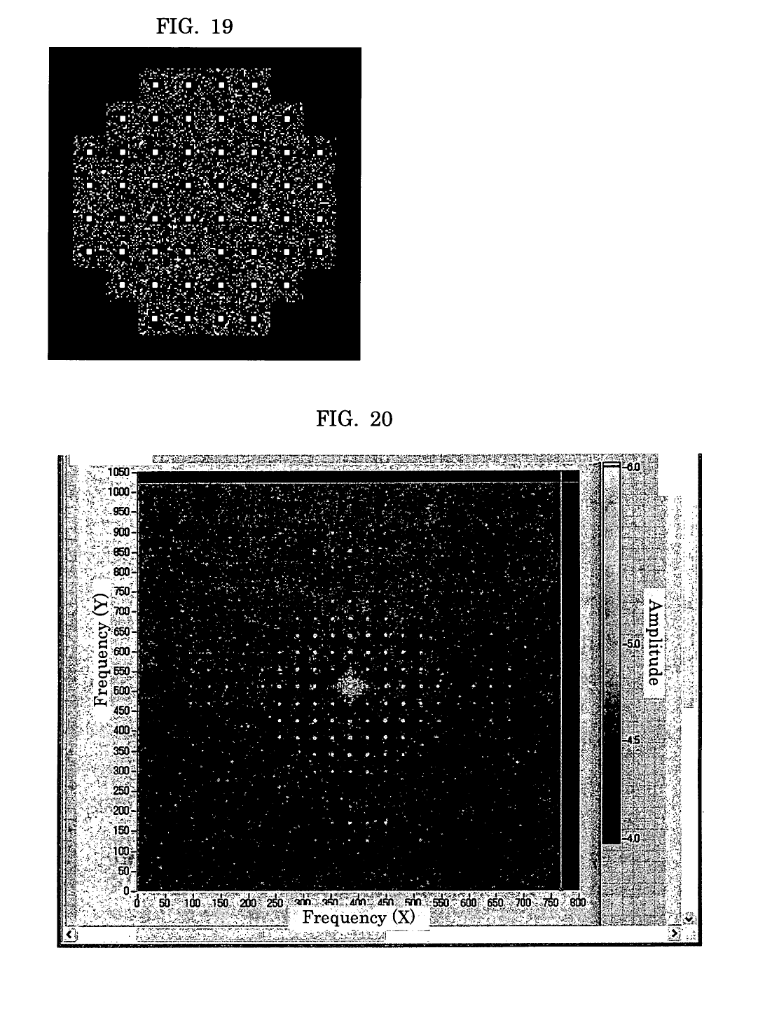

The number of sub-pixels contained in the information beam spot 33 is 4,096, and the size of each sub-pixel is about one-fourth the size of each of the 1,160 pixels shown in FIG. 1 for convenience purpose. In FIG. 19, separate, small white dots correspond to the sub-pixels and represent a bit of digital data expressed in “0” or “1.”

In the data area 34, each of the sub-pixels stores a bit of data (i.e., “0” or “1”), and interference fringes that result from interference between information and reference beams are recorded in the recording medium.

### <Synchronization Mark>

The synchronization marks are used as a reference for identification of the positions of digital data recorded in the data area 34 shown in FIG. 1, and all of the synchronization marks are assigned positional information—a reference in the information beam spot 33 —in the form of address, for example.

When the synchronization marks 35 have been detected upon reproduction of information, the positions of digital data are identified based on the positions of the synchronization marks 35, and therefore, the position of every digital data in the information beam spot 33 can be recognized, allowing all data in the spot to be reproduced in the form of a single page data pattern.

For the synchronization marks 35, digital data consisting of a specific set of “0s” and “1s” are used; therefore, the synchronization marks 35 can be distinguished as known image information from other digital data upon information reproduction.

The arrangement of the synchronization marks is not particularly limited as long as it is not a grid pattern as shown in FIG. 1, and can be appropriately determined depending on the intended purpose. Examples follow:

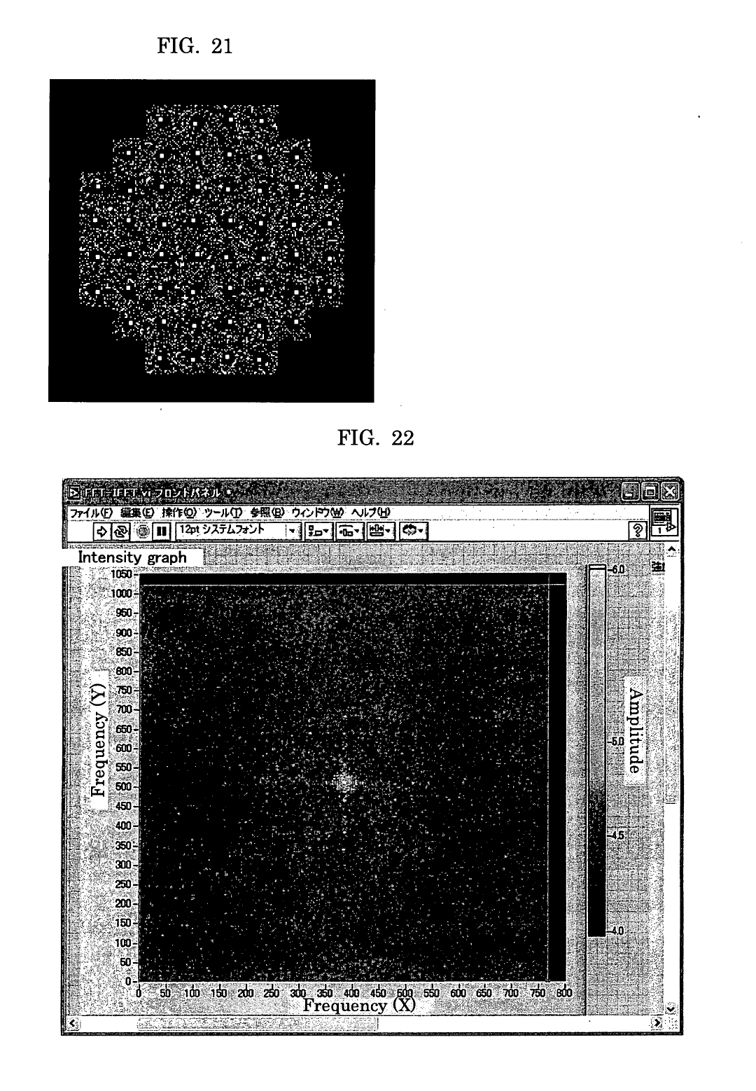

### (1) Arrangements as shown in FIGS. 2 and 21, wherein synchronization marks are randomly arranged both in vertical and horizontal directions;

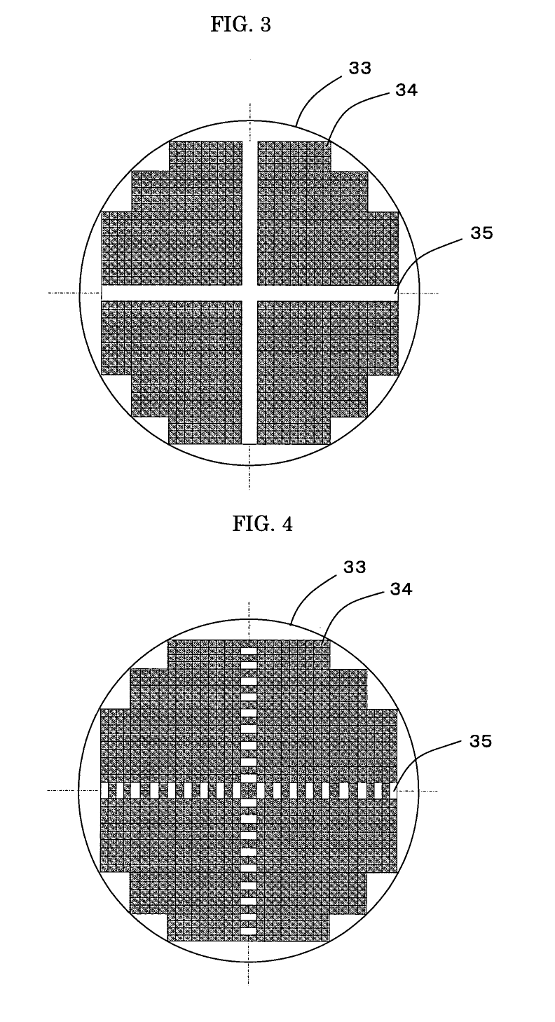

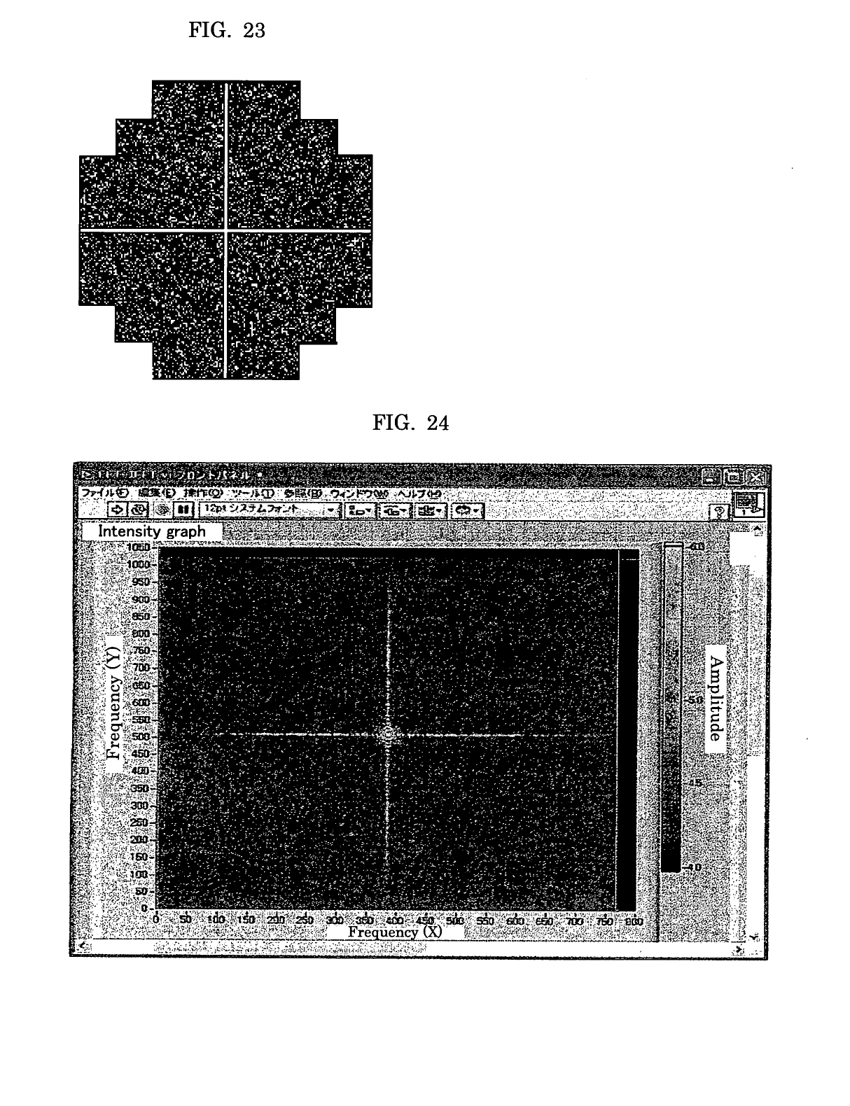

### (2) Arrangements as shown in FIGS. 3 and 23, wherein synchronization marks are arranged in a solid cross;

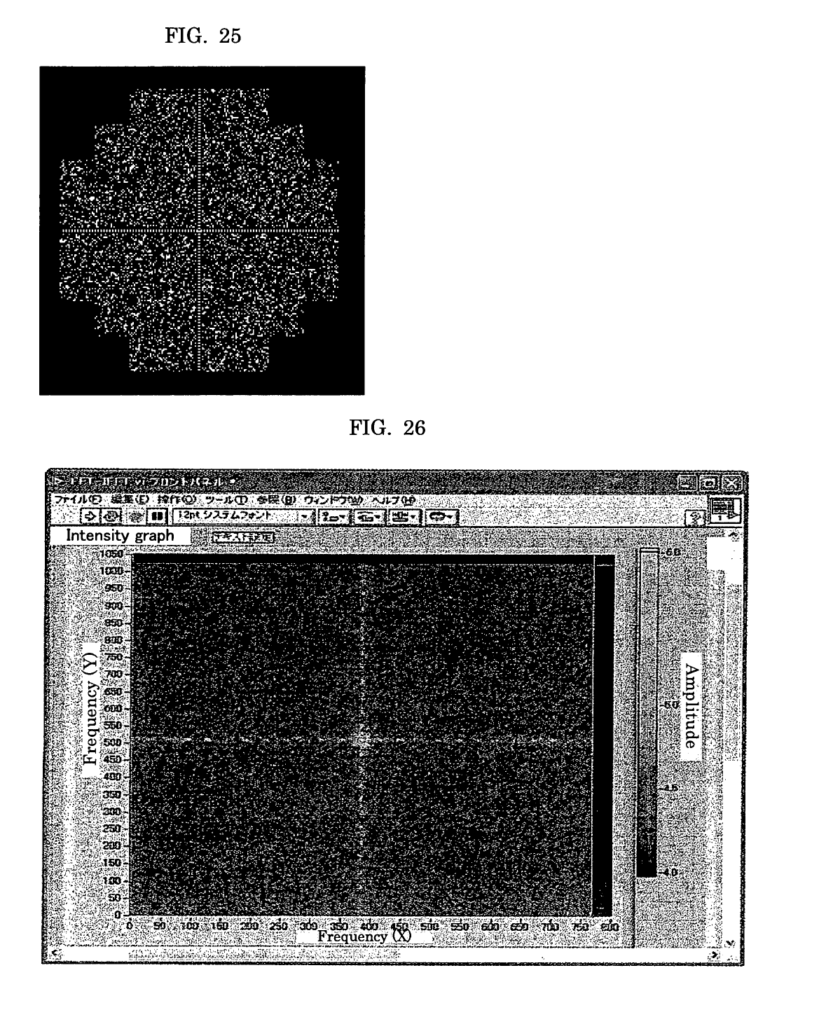

### (3) Arrangements as shown in FIGS. 4 and 25, wherein synchronization marks are arranged in a dotted cross;

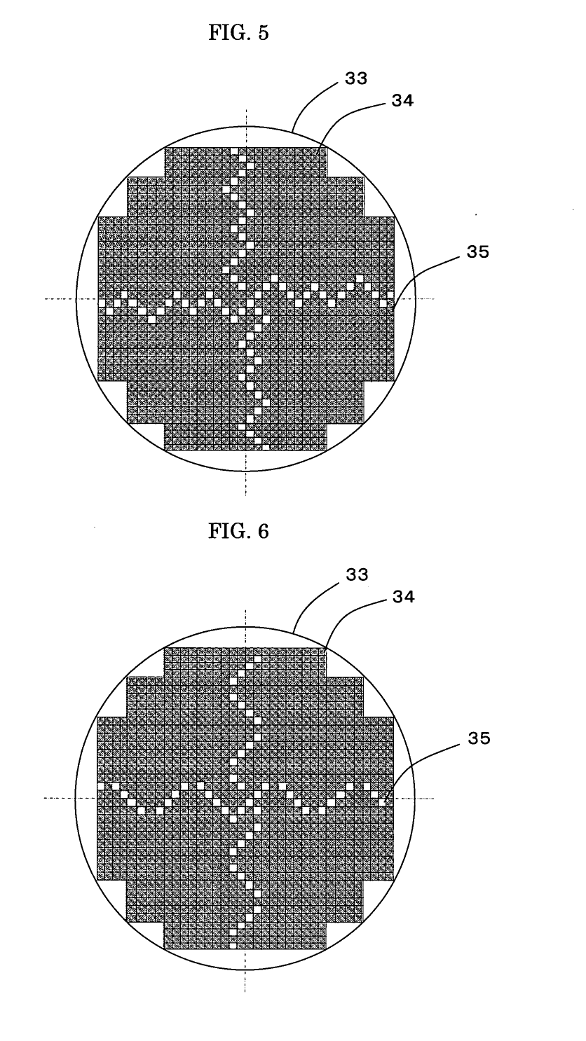

### (4) An arrangement as shown in FIG. 5, wherein synchronization marks are arranged in a zigzag cross;

### (5) An arrangement as shown in FIG. 6, wherein synchronization marks are arranged in a corrugated cross;

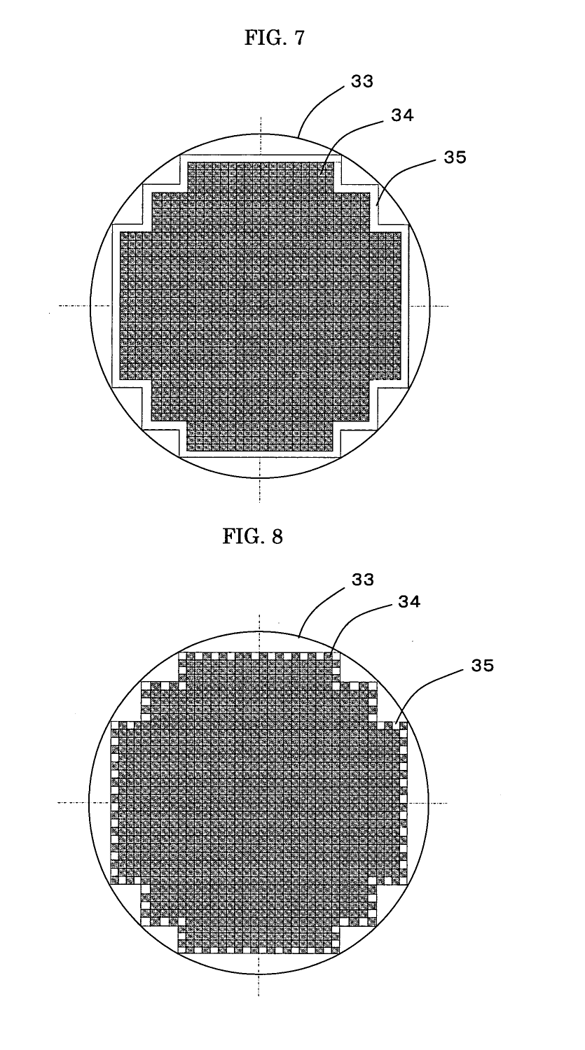

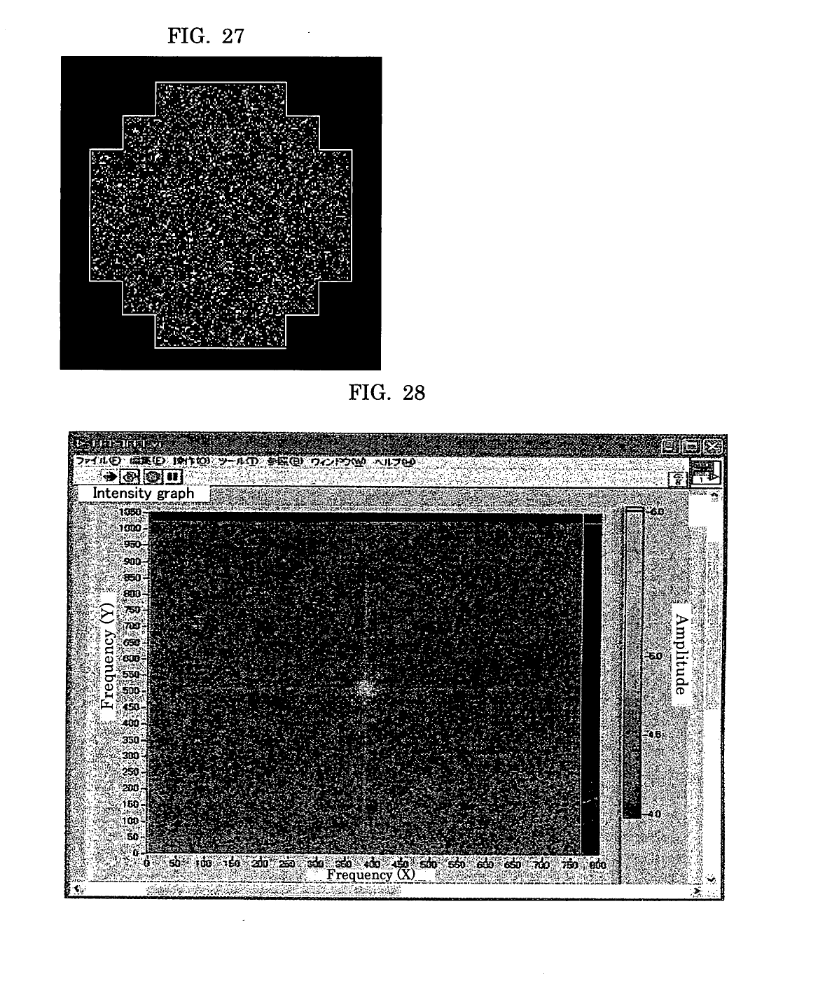

(6) Arrangements as shown in FIGS. 7 and 27, wherein synchronization marks are arranged in a solid line which encompasses the entire circumference of a data area 34 in an information beam pattern (page data pattern); and

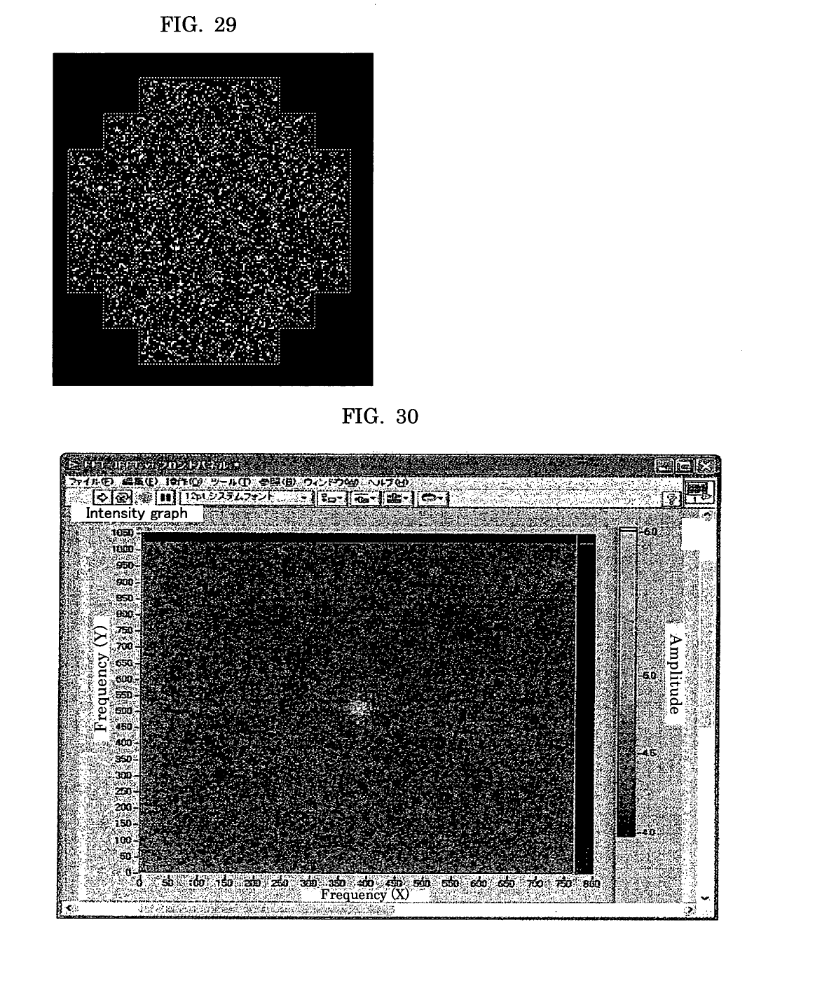

(7) Arrangements as shown in FIGS. 8 and 29, wherein synchronization marks are arranged in a dotted line which encompasses the entire circumference of a data area 34 in an information beam pattern (page data pattern)

The arrangement of (1) is advantageous particularly in that it is possible to increase the degree of irregularity in the arrangement of synchronization marks. More specifically, it can be seen from a Fourier-transformed image of a two-dimensional page data pattern, represented in terms of tone of the display monitor as shown in FIG. 22, that light intensity convergence can be suppressed that occurs at specific positions in the Fourier-transformed surface (in the vicinity of the beam focusing surface) due to regularity in the arrangement of synchronization marks, and that this arrangement can markedly suppress the generation light intensity convergence to a greater extent than does a grid-pattern arrangement (FIG. 20).

The arrangements of (2) and (3) can suppress the generation spot-like light intensity convergences particularly in a Fourier-transformed image. Thus, synchronization marks arranged in a dotted cross as shown in FIGS. 24 and 26 can suppress the generation of spot-like light intensity convergences in the light intensity distribution over a Fourier-transformed image to a greater extent than do synchronization marks arranged in a grid pattern shown in FIG. 20. Moreover, it can be learned that the synchronization marks arranged in a dotted line can prevent the generation of light intensity convergence more efficiently than those arranged in a solid line.

The arrangements of (4) and (5) have a pattern of less regular dotted lines as shown in FIGS. 5 and 6, thereby providing an effect of preventing the generation of light intensity convergence in a Fourier-transformed image of the pattern.

The arrangements of (6) and (7) can prevent the generation of light intensity convergence in a Fourier-transformed image as shown in FIGS. 28 and 30 to a greater extent than does a grid-pattern arrangement shown in FIG. 20. The effect of preventing the generation of light intensity convergence is high particularly in the case of a dotted line.

Among these arrangements, the arrangements of (1) as shown in FIG. 2 where synchronization marks are randomly arranged both in vertical and horizontal directions are most preferable in view of the fact that they are capable of effective prevention of generation of light intensity convergence in the light intensity distribution over a Fourier-transformed image, i.e., the beam focusing surface of the media.

If information is recorded as interference fringes that result by interference between information and reference beams, as with collinear technology-based optical recording methods, with synchronization marks arranged in a grid pattern, it causes an increase in the light intensity at specific positions in the vicinity of the beam focusing surface of the media (Fourier-transformed surface) as shown in FIG. 20, due to the regularity in the arrangement of the synchronization marks. Accordingly, information is recorded in those specific positions with higher light intensity than in other areas. When shift-multiplexing recording is conducted with this recording strategy, cycles of this periodical high-light intensity recording are repeated, leading to undesirable generation of diffraction noise upon information reproduction.

When synchronization marks are arranged in a dot line, the interval between adjacent synchronization marks is not particularly limited and can be appropriately determined depending on the intended purpose; for example, the interval or distance is preferably an integer multiple of a minimum pixel interval adopted in a spatial light modulator. In this case, it is possible to expand light intensity to the edge of the Fourier-transformed surface, i.e., higher frequencies, because the interval in the dotted line is proportional to the minimum pixel interval.

An interval that is not an integer multiple of a minimum pixel interval of a spatial light modulator makes it difficult to distinguish between a synchronization mark pattern and a data pattern, resulting in failure to provide their original function of position identification in some cases.

The number of forms in which the synchronization marks are arranged is not particularly limited and can be appropriately determined depending on the intended purpose as long as at least one kind of form is present in the information beam pattern; however, it is preferable that the synchronization marks be arranged in two or more different forms.

If synchronization marks are present only in one form, it may result in insufficient light diffusion effect in a Fourier-transformed surface, whereas a combination of many different forms may result in a complex algorithm for data position identification during information reproduction.

It is only necessary for the synchronization mark form to allow recognition of a pattern that has been previously set in the system. More specifically, for example, the synchronization mark form may be a cluster of specific pixels (e.g., 16 pixels (4×4)), each of which represents “1”; may be specific pixels in which only given pixels previously defined by the system represent “1”; and so forth. Furthermore, the synchronization mark form may be a sequence of pixels, which is of specific length and specific shape (e.g., straight line, cross line, or curved line), each of the pixels presenting “1”; may be a sequence of pixels, which is of specific length and specific shape, where “1” is represented at specific intervals (e.g., alternating pixels represent “1”); and so forth.

The optical recording method of the present invention may be, for example, angle-multiplexing recording or shift-multiplexing recording. The optical recording medium in which information is recorded by the optical recording method may record a transmissive hologram or a reflective hologram; any holograms can be used, such as amplitude holograms, phase holograms, blazed holograms, and complex amplitude holograms.

### <Shift-Multiplexing Recording>

As shown in FIG. 9, multiplexing recording is conducted as follows: An information beam and a reference beam 39 are passed through an objective lens 12 and focused on a predetermined position of a recording layer to form a recording spot 33 of given size thereon, creating an interference image by optical interference between the information and reference beams and allowing the interference image thus created to be recorded in the recording layer. Repeating this cycle, interference fringes—each of which corresponds to information for one recording spot—are continuously recorded in the same track of the recording layer at predetermined intervals between them (first recording operation). Subsequently, the beam irradiation position of the medium is slightly shifted from the initial recording position by a distance corresponding to a predetermined recording pitch along the disc's perimeter. A second recording operation is then performed, whereby interference fringes are sequentially overlaid on the first interference fringes. After the second recording operation has been conducted on the entire track as in the first recording operation, the beam irradiation position of the medium is again shifted as in the first recording operation, followed by a third recording operation whereby interference fringes are sequentially overlaid on the first and second interference fringes. In this way interference fringes are overlaid (recorded) on top each other while sequentially moving the beam spot or recording layer. Moreover, the recorded interference fringes are fixed to the recording layer by a fixing step that involves application of a fixing beam.

The interference image is a pattern of light and dark fringes. In the light fringes photosensitive monomers are converted to polymers by photopolymerization and thus the refraction index of the recording layer corresponding to the light fringes is reduced, creating a difference in refractive index between the dark fringes, where no photopolymerization reaction has occurred, and the light fringes. The interference images are recorded as the difference in refractive index. Accordingly, the dark fringes correspond to non-recorded regions of the recording layer, where light fringes for the next recording can be recorded.

The shift pitch is preferably a minimal pitch that never allows the second interference image to be reacted with a reproduction beam applied for the reproduction of the initial (first) interference image adjacent to the second interference image.

In the case of the collinear technology in which the information beam and reference beam are applied in such a way that the optical axis of the information beam is collinear with that of the reference beam, the reproduction beam never reacts with adjacent interference images if the interval between adjacent interference images is about 3 μm to 5 μm (recording pitch shown in FIG. 9). Thus, multiplexing recording is achieved with a pitch of about 3 μm to 5 μm.

The smaller the pitch is, the greater the degree of multiplexity, leading to an increase in the storage capacity. However, the diffraction efficiency, which represents the definition of a holographic image to be reconstructed, decreases as the degree of multiplexing increases, imposing a limitation on the number of the multiplexed interference images.

In addition, exposure dose (mJ/cm²) needs to be increased as the degree of multiplexity increases.

When a photopolymer recording material is used for the recording layer, the first interference image can be recorded at low energy. However, subsequent continuous exposure operations lead to a larger reacted (exposed) region, and the sensitivity of the recording material is reduced, thus requiring high-irradiation energy to achieve as excellent recording quality as the first one. As described above, the reason why high irradiation energy is required is that the reacted region inhibits the reaction of non-reacted (non-exposed), and/or that the amounts of photosensitive compositions (e.g., photopolymers) in the non-reacted region are reduced.

The shifting method in the shift-multiplexing recording is not particularly limited as long as the information and reference beams and the surface of the recording layer are linearly shifted in a relative manner, and can be appropriately determined depending on the intended purpose. For example, a disc may be moved in the rotational (tracking) direction.

The shifting device in the shift-multiplexing recording is not particularly limited and can be appropriately selected depending on the intended purpose. For example, a tracking servo or DLP (Digital Light Processor) can be used.

The shift distance in the shift-multiplexing recording is not particularly limited as long as the reproduction beam applied onto a recording region never reacts with adjacent recording regions, and can be appropriately determined depending on the intended purpose. For example, the shift distance is preferably 3 μm to 30 μm. If the shift distance is less than 3 μm, recording regions other than the one to be reproduced react with the reproduction beam to generate ghost images, whereas if the shift distance exceeds 30 μm, it results in failure to exploit the advantage of the shift-multiplexing recording due to reduced storage capacity as an optical recording medium.

### <Fixing Beam>

The fixing beam is applied to the recording layer so as to stabilize the interference image recorded therein.

The method of fixing beam application is not particularly limited and can be appropriately determined depending on the intended purpose. The fixing beam may be emitted from the same light source as the information and reference beams or may be emitted from a different light source.

### <Method of Recorded Optical Information Reproduction>

The method for reproducing recorded optical information is not particularly limited and can be appropriately selected depending on the intended purpose. For example, reproduction of recorded optical information is performed by applying a reference beam to an optical recording medium, where information has been recorded with the optical recording method of the present invention, from the same direction as the reference beam for recording is applied. Applying the reference beam to an interference image formed in the recording layer of the optical recording medium creates diffracted rays that correspond to the interference image, and the optical information is reproduced by collecting them with a CCD or the like.

### (Optical Recording Apparatus)

The optical recording method and optical reproduction method of the present invention are performed by the optical recording apparatus.

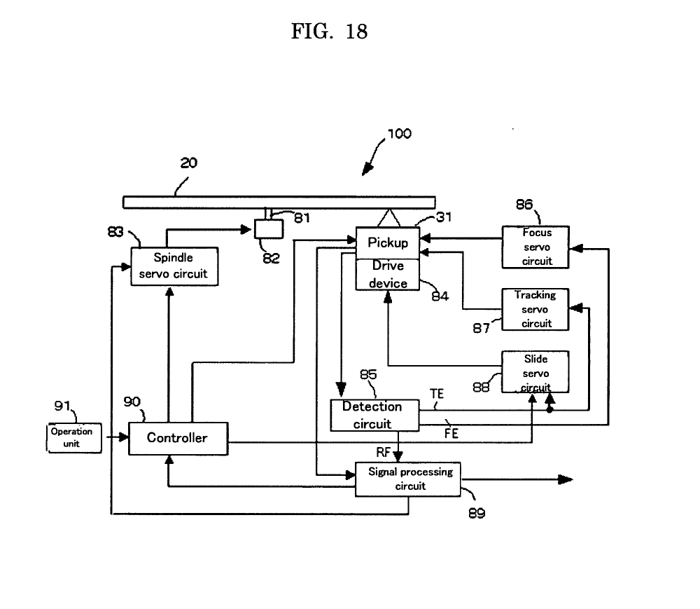

The optical recording apparatus used for the method for recording and reproducing optical information will be described with reference to FIG. 18.

FIG. 18 is a block diagram showing the configuration of an optical recording apparatus according to the second form. Note that this apparatus includes an optical recording device and an optical reproducing device.

The optical recording apparatus 100 includes a spindle 81 to which an optical recording medium 20 is attached, a spindle motor 82 for spinning the spindle 81, and a spindle servo circuit 83 for controlling the spindle motor 82 so that the rotation speed of the optical recording medium 20 is constant at a predetermined level.

In addition, the optical recording apparatus 100 includes a pickup 31 which applies an information beam and a recording reference beam onto the optical recording medium 20 and which applies a reproduction reference beam onto the optical recording medium 20 to detect a reproduction beam for the reproduction of information recorded in the optical recording medium 20, and a drive device 84 that enables the pickup 31 to move in the radial direction of the optical recording medium 20.

The optical recording apparatus 100 includes a detection circuit 85 for detecting a focus error signal FE, a tracking error signal TE and a reproduction signal RF from the output signal of the pickup 31, a focus servo circuit 86 for performing a focus servo operation by driving an actuator inside the pickup 31 on the basis of the focus error signal FE detected by the detection circuit 85 to move an objective lens (not shown) in the thickness direction of the optical recording medium 20, a tracking servo circuit 87 for performing a tracking servo operation by driving an actuator inside the pickup 31 on the basis of the tracking error signal TE detected by the detection circuit 85 to move the objective lens in the radial direction of the optical recording medium 20, and a slide servo circuit 88 for performing a slide servo operation by controlling the drive device 84 on the basis of a tracking error signal TE and commands from a controller to be described later to move the pickup 31 in the radial direction of the optical recording medium 20.

Furthermore, the optical recording apparatus 100 includes a signal processing circuit 89 which decodes output data from a CMOS or CCD array to be described later in the pickup 31 to reproduce data recorded on the data area of the optical recording medium 20; which creates a reference clock on the basis of a reproduction signal RF detected by the detection circuit 85; and which distinguishes individual addresses, a controller 90 for controlling overall of the optical recording apparatus 100, and an operation unit 91 for giving a variety of commands to the controller 90.

The controller 90 receives the reference clock and address information outputted from the signal processing circuit 89 and controls, for example, the pickup 31, spindle servo circuit 83 and slide servo circuit 88. The spindle servo circuit 83 receives the reference clock outputted from the signal processing circuit 89. The controller 90 includes a CPU (Central Processing Unit), ROM (Read Only Memory) and RAM (Random Access Memory), and the CPU realizes the function of the controller 90 by executing programs stored in the ROM on the RAM, a working area.

### <Optical Recording Medium>

The optical recording medium of the present invention is an optical recording medium that has a recording layer on a substrate for recording information by holography, and further has additional layers over the substrate on an as-needed basis.

The optical recording medium of the present invention may record either a relatively thin, flat hologram for recording two-dimensional image data or a volume hologram for recording three-dimensional image data. In either case, the optical recording medium of the present invention may record either a transmissive hologram or a reflective hologram. In addition, any holographic recording method can be used; for example, amplitude holograms, phase holograms, blazed holograms, complex amplitude holograms, etc., can be used.

The optical recording medium of the present invention is preferably an optical recording medium that includes at least a first substrate, a second substrate, a recording layer formed on the second substrate, and a filter layer formed between the first and second substrates, wherein the collinear technology is employed in which information and reference beams are applied in such a way that the optical axis of the information beam is collinear with that of the reference beam.

### <First Substrate>

The shape, structure, size and the like of the first substrate are not particularly limited and can be appropriately set depending on the intended purpose; examples of the shape of the first substrate includes a disc shape, card-like flat shape, and sheet shape; examples of the structure of the first substrate include a single-layer structure and multilayered structure; and the size of the first substrate can be appropriately set according to the size of the optical recording medium, for example.

Materials of the first substrate are not particularly limited, and inorganic and organic materials can be suitably used. However, organic and inorganic materials are required that can ensure mechanical strength of optical recording media. In addition, when the first substrate is transparent enough to admit recording and reproduction beams, organic and inorganic materials that can admit these beams are required.

Examples of the inorganic materials include glass, quartz and silicon.

Examples of the organic materials include acetate resins such as triacetylcellulose, polyester resins, polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinylalcohol resins, polyvinyl chloride resins, polyvinylidene chloride resins, polyacrylic resins, polylactate resins, plastic film laminate paper and synthetic paper. These may be used singly or in combination. Among these, polycarbonate resins and acrylic resins are preferable in light of their formability, optical characteristics, and costs.

The first substrate may be either a freshly prepared one or a commercially available one.

The thickness of the first substrate is not particularly limited and can be appropriately set depending on the intended purpose; the thickness is preferably 0.1 mm to 5 mm, more preferably 0.3 mm to 2 mm. If the thickness of the first substrate is less than 0.1 mm, the optical information disc containing the first substrate may become deformed. If the thickness is greater than 5 mm, the weight of the optical information disc is increased, so too does the load on a drive motor that spins it.

### —Second Substrate—

The shape, structure, size and the like of the second substrate are not particularly limited and can be appropriately set depending on the intended purpose; examples of the shape of the second substrate includes a disc shape and card-like shape, and material that can ensure the mechanical strength of the resultant optical recording medium needs to be selected. In addition, when a beam of light for recording and reproduction is incident through the second substrate, the substrate needs to be transparent enough to admit light of a desired wavelength.

For the material of the second substrate, glass, ceramics, resins and the like are generally used; however, resins are most preferable in view of their formability and costs.

Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics, and costs.

The second substrate may be either a freshly prepared one or a commercially available one.

Multiple numbers of address-servo areas—addressing areas linearly extending in the radial direction of the substrate—are provided on the substrate at given angles to one another, and each fan-shaped area between adjacent address-servo areas serves as a data area. In the address-servo areas, information for performing a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits are used as the information for tracking servo. Note that there is no need to provide the servo pit pattern in a case where the optical recording medium is card-like shape.

The thickness of the second substrate is not particularly limited and can be appropriately set depending on the intended purpose; the thickness is preferably 0.1 mm to 5 mm, more preferably 0.3 mm to 2 mm. If the thickness of the second substrate is less than 0.1 mm, the optical disc may become deformed during storage. If the thickness is greater than 5 mm, the weight of the optical disc is increased, so too does the load on a drive motor that spins it.

### —Reflective Film—

The reflective film is formed on the surface of the servo pit pattern of the substrate.

For the material of the reflective film, materials that offer high reflectivity to a recording beam and reference beam are preferable. When the wavelength of light to be adopted is 400 nm to 780 nm, Al, Al alloys, Ag, Ag alloys and the like are preferably used. When the wavelength of light to be adopted is 650 nm or more, Al, Al alloys, Ag. Ag alloys, Au, Cu alloys, TiN and the like are preferably used.

By using an optical recording medium which reflects light by a reflective film and can record or erase information—for example, DVD (Digital Versatile (Video) Disc), directory information indicative of the locations where information has been recorded, the time when information has been recorded, and the locations where errors have occurred and how information has been re-recorded on spare areas can also be recorded on, and erased from the optical recording medium without adversely affecting holograms.

The method for forming the reflective film is not particularly limited and can be appropriately selected depending on the intended purpose; examples thereof include various types of vapor deposition, such as a vacuum vapor deposition, sputtering, plasma CVD, photo CVD, ion plating, and electron beam vapor deposition. Among these, sputtering is most preferable in view of mass productivity, film quality, and the like.

The thickness of the reflective film is preferably 50 nm or more, more preferably 100 nm or more, in order to secure sufficient reflectivity.

### <Recording Layer>

For recording layer material, materials that can record information by holography and undergo changes in their optical characteristics (e.g., absorption index and/or refractive index) upon irradiation with electromagnetic rays (e.g., γ-ray, X-ray, ultraviolet ray, visible light ray, infrared ray, and radio waves) with predetermined wavelength are used.

The recording layer material contains photothermal conversion material, a photosensitive resin, and a binder, and further contains an additional component appropriately selected on an as-needed basis.

### —Photosensitive Resin—

The photosensitive resin is not particularly limited as long as it is used for holograms and can be appropriately selected depending on the intended purpose. For example, photopolymers are preferable.

### —Photopolymer—

The photopolymer is not particularly limited and can be appropriately selected depending on the intended use. For example, the photopolymer contains a monomer and a photoinitiator and further contains additional components such as a sensitizer and/or oligomers on an as-needed basis.

For the photopolymer, for example, those described in the following can be used: “Photopolymer Handbook” (published by Kogyo Chosakai Publishing Inc., 1989), “Photopolymer Technology” (published by THE NIKKAN KOGYO SHIMBUN LTD., 1989), SPIE Journals and Proceedings Vol. 3010 on pp 354-372 (1997), and SPIE Journals and proceedings Vol. 3291 pp 89-103 (1998). In addition, it is also possible to use the photopolymers described in U.S. Pat. Nos. 5,759,721, 4,942,112, 4,959,284, 6,221,536, and 6,743,552; International Publication Nos. WO/97/44714, 97/13183, 99/26112, and 97/13183; Japanese Patent (JP-B) Nos. 2880342, 2873126, 2849021, 3057082, and 3161230; and Japanese Patent Application Laid-Open (JP-A) Nos. 2001-316416 and 2000-275859.

Examples of the method for applying a recording beam to the photopolymer to change the optical properties thereof include a method utilizing diffusion of low-molecular components. In addition, in order to mitigate change in volume of the photopolymer at the time of polymerization, a component that diffuses in the direction opposite to the direction in which polymerized components are diffused may be added, or a compound having a structure that breaks up by treatment with acids may be added in addition to polymers. When the recording layer is formed using a photopolymer containing the low-molecular component, the recording layer may need a structure that can retain liquid therein. Moreover, when the compound having a structure that breaks up by treatment with acids is added, the change in volume of the photopolymer may be constrained by counterbalancing expansion caused by the structure break up and shrinkage caused by polymerization of monomers.

The monomer is not particularly limited can be appropriately selected in depending on the intended use; examples thereof include radical polymerizable monomers having a unsaturated bond such as acrylic group and methacrylic group, and cationic polymerizable monomers having an ether structure such as epoxy ring and oxetane ring. Each of these monomers may be monofunctional or polyfunctional. Photocrosslinking monomers may also be used. The radical polymerizable monomer is not particularly limited and can be appropriately selected depending on the intended use;

examples thereof include acryloylmorpholine, phenoxyethylacrylate, isobonylacrylate, 2-hydroxypropylacrylate, 2-ethylhexylacrylate, 1,6-hexanedioldiacrylate, tripopyleneglycol diacrylate, neopentylglycol PO-modified diacrylate, 1,9-nonanedioldiacrylate, hydroxy pivalic acid neopentylglycol diacrylate, EO-modified bisphenol A diacrylate, polyethyleneglycol diacrylate, pentaerythritol triacrylate, pentaerythritol tetraacrylate, pentaerythritol hexaacrylate, EO-modified glycerol triacrylate, trimethylol propane triacrylate, EO-modified trimethylol propane triacrylate, 2-naphtho-1-oxyethyl acrylate, 2-carbazoil-9-ethylacryate, (trimethylsilyloxy) dimethylsilylpropyl acrylate, vinyl-1-naphthoate, N-vinyl carbazole, 2,4,6-tribromophenylacrylate, pentabromoacrylate, phenyltioethylacrylate, and tetrahydrofurfurylacrylate.

Examples of the cationic polymerizable monomer include bisphenol A epoxy resins, phenol novolac epoxy resins, glycerol triglycidyl ether, 1,6-hexane glycidyl ether, vinyltrimethoxysilane, 4-vinylphenyl trimethoxysilane, γ-methacryroxypropyl triethoxysilane, and compounds represented by the following formulas (M1) to (M6). These monomers may be used singly or in combination.

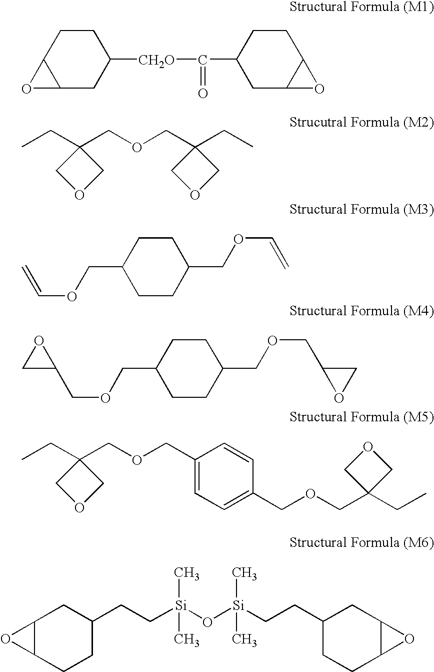

The photoinitiator is not particularly limited as long as it is sensitive to a recording beam, and examples thereof include materials that can trigger radical polymerization, cationic polymerization, and crosslinking reactions.

Examples of the photoinitiator include 2,2′-bis(o-chlorophenyl)-4,4′, 5,5′-tetraphenyl-1,1′-biimidazole, 2,4,6-tris(trichloromethyl)-1,3,5-triazine, 2,4-bis (trichloromethyl)-6-(p-methoxyphenylvinyl)-1,3,5-triazine, diphenyl iodonium tetrafluoroborate, diphenyl iodonium hexafluorophosphate, 4,4′-di-t-butylphenyl iodonium tetrafluoroborate, 4-diethylaminophenylbenzene diazonium hexafluorophotophate, benzoin, 2-hydroxy-2-methyl-1-phenylpropane-2-one, benzophenon, thioxanthone, 2,4,6-trimethyl benzoyl diphenyl acyl phosphine oxide, triphenyl butylborate tetraethylammonium, bis(η5-2,4-cyclopentadiene-1-yl), bis[2,6-difluoro-3-(1H-pyrrole-1-yl)phenyltitanium], and diphenyl-4-phenylthiophenylsulfonium hexafluorophosphate. these photoinitiators may be used singly or in combination. In addition, sensitizing pigments may be used together with the photoinitiator, depending on the wavelength of beam to be applied.

Polymerization inhibitors and/or antioxidants may be added in order to improve the shelf life of the recording layer. Examples of such polymerization inhibitors and antioxidants include hydroquinones, p-benzoquinone, hydroquinone monoethylether, 2,6-di-t-butyl-p-cresol, 2,2′-methylenebis(4-methyl-6-t-butylphenol), triphenyl phosphite, trisnonylphenyl phosphite, phenothiazine, and N-isopropyl-N′-phenyl-p-phenylenediamine. The amount to be added is 3% by mass or less of the total monomers; if it exceeds 3% by mass, the rate of polymerization reactions may be reduced, or polymerization reactions never take place in some cases.

The photopolymer can be obtained by mixing the monomer, the photoinitiator, and other components in accordance with the necessity to allow them to react with one another. When the obtained photopolymer has a substantially low viscosity, it can be formed into a recording layer by casting. If the obtained photopolymer has too high a viscosity to be formed into a recording layer, a recording layer can be formed in the following manner: The photopolymer is deposited onto the second substrate using a dispenser, and the first substrate is then pressed against the photopolymer just like putting a lid thereon, whereby the photopolymer is spread over the first substrate to form a recording layer.

Examples of useful photosensitive resins other than the foregoing photopolymers include (1) photorefractive materials that offer a photorefractive effect—an effect that a space-charge distribution is generated as a result of light irradiation, and the refractive index is altered), (2) photochromic materials that undergo changes in refractive index upon irradiation with light, caused by isomerization of their molecules, (3) inorganic materials such as lithium niobate, and barium titanate, and (4) chalcogen materials.

The photorefractive materials (1) are not particularly limited as long as they offer a photorefractive effect, and can be appropriately selected depending on the intended purpose. For example, the photorefractive materials contain charge generating material and charge transporting material, and further contain additional components on an as-needed basis.

The charge generating material is not particularly limited and can be appropriately selected depending on the intended purpose; examples thereof include phthalocyanine dyes or pigments such as metallophthalocyanine, metal-free phthalocyanine and derivatives thereof; naphthalocyanine dyes or pigments; azo dyes or pigments such as monoazo, disazo and trisazo dyes and pigments; pelylene dyes or pigments; indigo dyes or pigments; quinacridone dyes or pigments; polycyclic quinone dyes or pigments such as anthraquinones, and Anthanthron; cyanine dyes or pigments; charge-transfer complexes comprising an electron-accepting substance and an electron-donating substance as typified by TIF-TCNQ; azulenium salts; fullerenes as typified by C₆₀ and C₇₀ and metanofullerenes, derivatives of fullenerens. These charge generating materials may be used singly or in combination.

The charge transporting material is material carrying holes or electrons, and may be a low-molecular compound or a high-molecular compound.

The charge transporting material is not particularly limited and can be appropriately selected depending on the intended purpose; examples thereof include nitrogen-containing cyclic compounds such as indoles, carbazoles, oxazoles, inoxazoles, thiazoles, imidazoles, pyrazoles, oxadiazoles, pyrazolines, thiadiazoles and triazoles or derivatives thereof; hydrazoline compounds; triphenyl amines; triphenylmethanes; butadienes; stilbenes; quinone compounds such as anthraquinon diphenoquinons or derivatives thereof; fullerenes such as C₆₀ and C₇₀ and derivatives thereof; π conjugate high polymers or oligomers such as polyacetylenes, polypyrroles, polythiophenes and polyanilines; σ conjugate high polymers or oligomers such as polysilanes and polygermanes; and polycyclic aromatic compounds such as anthracenes, pyrenes, phenanthrenes, and coronenes. These charge transporting materials may be used singly or in combination.

The following is an example of the method for forming a recording layer using the photorefractive material: a coating solution obtained by dissolving and dispersing the photorefractive material in a solvent is used to prepare a coated film, and the solvent is removed from the coated film to thereby form a recording layer. It is also possible to form a recording layer in the following manner: The photorefractive material is fluidized by heating to prepare a coated film, and the coated film is then quenched to form a recording layer.

The photochromic materials (2) are not particularly limited as long as they can induce a photochromic reaction, and can be appropriately selected depending on the intended use; examples thereof include azobenzene compounds, stilbene compounds, indigo compounds, thioindigo compounds, spiropyran compounds, spirooxazine compounds, fulgide compounds, anthracenes compounds, hydrazone compounds, cinnamic acid compounds and diarylethene compounds. Of these compounds, azobenzene derivatives and stilbene derivatives, which undergo structural changes as a result of cis-trans isomerism upon irradiation with light; and spiropyran derivatives and spirooxazine compounds, which undergo structural changes (ring-opening and ring-closure) upon irradiation with light, are most preferable.

Examples of the chalcogen materials (4) include materials containing chalcogen element-containing chalcogenide glass plus metallic particles which are dispersed in the chalcogenide glass and which can upon irradiation with light diffuse in the chalcogenide glass.

The chalcogenide glass is not particularly limited as long as it is composed of a nonoxide amorphous material containing a chalcogen element such as S, Te, or Se and metallic particles can be photo-doped therein.

Preferred examples of amorphous materials containing chalcogen elements include Ge—S glasses, As—S glasses, As—Se glasses and As—Se—Ce glasses. Of these glasses, Ge—S glasses are preferably used. When Ge—S glass is used for the chalcogenide glass, the atomic ratio between Ge and S in the Ge—S glass can be suitably changed depending on the wavelength of light beam to be applied. However, chalcogenide glasses composed primarily of a composition represented by GeS₂ are preferably used.

The metallic particles are not particularly limited as long as they can be doped in the chalcogenide glass upon irradiation with light, and can be appropriately selected depending on the intended use; examples thereof include Al, Au, Cu, Cr, Ni, Pt, Sn, In, Pd, Ti, Fe, Ta, W, Zn and Ag. Among these, Ag, Au, and Cu are more likely to be photo-doped in chalogenide glass, and Ag is most preferable because it has excellent photodoping performance.

The content of the metallic particles dispersed in the chalcogenide glass is preferably 0.1% by volume to 2% by volume, more preferably 0.1% by volume to 1.0% by volume of the total volume of the recording layer. If the content of the metallic particles is less than 0.1% by volume, the change in transmittance as a result of photodoping is insufficient, which may result in the reduction in the recording accuracy. Whereas if the content of the metallic particles is more than 2% by volume, the light transmittance of the recording material decreases, leading to unsatisfactory photodoping in some cases.

### —Binder—

The binder is added in order to increase coating capability, strength of the resultant film and holographic recording characteristics, and is appropriately selected in light of its compatibility with hologram material and photothermal conversion material.

The binder is not particularly limited and can be appropriately selected depending on the intended purpose; examples thereon include copolymers of unsaturated acids (e.g., (meth)acrylic acid and itaconic acid) and alkyl(meth)acrylates, phenyl(meth)acrylate, benzyl (meth)acrylate, styrene or α-methylstyrene; polymers of alkyl methacrylates and alkyl acrylates, such as polymethyl methacrylate; copolymers of alkyl(meth)acrylates and acrylonitrile, vinyl chloride, vinylidene chloride or styrene; copolymers of acrylonitrile and vinyl chloride or vinylidene chloride; modified celluloses bearing carboxylic groups on their side chain; polyethyleneoxides; polyvinylpyrrolidones; novolac resins that result from the condensation reaction of phenol, o-cresol, m-cresol, p-cresol and/or xylenol and aldehydes and acetone; polyethers of epichlorohydrin and bisphenol A; soluble nylons; polyvinylidene chloride; chlorinated polyolefins; copolymers of vinyl chloride and vinyl acetate; copolymers of acrylonitrile and styrene; copolymers of acrylonitrile, butadiene and styrene; polyvinylalkylethers; polyvinylalkylketones; polystyrenes; polyurethanes; polyethylene terephthalate isophthalates; acetyl celluloses; acetylpropyloxy celluloses; acetylbutoxy celluloses; nitro celluloses; Celluloid; polyvinyl butyral; epoxy resins; melamine resins; and formalin resins. Note that the term “(meth)acryl” is used in some cases to denote both or either of “acryl” and/or “methacryl.”

The content of the binder is the solid components of the recording layer is not particularly limited and can be appropriately set depending on the intended purpose; it is preferably 10% by mass to 95% by mass, more preferably 35% by mass to 90% by mass. If the content of the binder is less than 10% by mass, interference images may not be obtained stably, whereas if the content exceeds 95% by mass, it may result in poor diffraction efficiency.

The content of the binder in the photosensitive layer is preferably 10% by mass to 95% by mass, more preferably 35% by mass to 90% by mass of the total solid components in the photosensitive layer.

### —Additional Component Contained in the Recording Layer—

In the present invention it is preferable to add nitro cellulose to the recording layer in order to improve the photothermal conversion effect. Nitro cellulose decomposes under heat generated from a light absorber that has absorbed the near-infrared laser beam, thereby facilitating the polymerization reaction in photopolymers.

The nitrocellulose can be prepared in the following procedure: Natural cellulose purified with a conventional method is esterified with mix acid, and nitro groups are entirely or partially introduced into three hydroxyl groups on the glucopyranose ring, a building block of cellulose. The nitrification degree in the nitrocellulose is preferably 2 to 13, more preferably 10 to 12, most preferably 11 to 12.5. Here, the term “nitrification degree” represents mass % of nitrogen atoms in nitrocellulose. If the nitrification degree is too high, through the polymerization reaction in the photopolymers is facilitated, it may result in the reduction in room temperature stability. In addition, the resultant nitrocellulose becomes explosive, which is dangerous. If the nitrification degree is too low, the polymerization reaction in the photopolymers is not facilitated well enough.

The degree of polymerization of the nitrocellulose is preferably 20 to 200, more preferably 25 to 150. If the degree of polymerization is too high, it may result in failure to remove the recording layer completely. If the degree of polymerization is too low, coating capability of the recording layer tends to be reduced. The content of the nitrocellulose in the recording layer is preferably 80% by mass or less, more preferably 0.5% by mass to 50% by mass, most preferably 1% by mass to 25% by mass of the total solid components in the recording layer.

The recording layer can be formed with a method known in the art. For example, the recording layer can be suitably formed with, for example, the vapor deposition method, wet deposition method, MBE (molecular beam epitaxy) method, cluster ion beam method, molecular lamination method, LB (Langumuir-Blodgett) method, printing method, or transferring method Alternatively, the recording layer may be formed with a two-component urethane matrix formation method described in U.S. Pat. No. 6,743,552.

The formation of the recording layer by means of the wet deposition method can be suitably performed by, for example, using a coating solution obtained by dissolving and dispersing the recording layer material in a solvent, (i.e., by applying the coating solution on a support and drying it). The wet deposition method is not particularly limited and can be appropriately selected from those known in the art depending on the intended use; examples thereof include an ink-jetting, spin coating, kneader coating, bar coating, blade coating, casting, dipping, and curtain coating.

The thickness of the recording layer is not particularly limited and can be appropriately set depending on the intended purpose; the thickness of the recording layer is preferably 1 μm to 1,000 μm, more preferably 100 μm to 700 μm.

If the thickness of the recording layer is within a preferable range, it will result in excellent S/N ratios even after 10- to 300-fold shift-multiplexing recording; more excellent S/N ratios can be obtained in a more preferable thickness range.

### <Filter Layer>

The filter layer serves to eliminate the occurrence fluctuations in the wavelengths selected to be reflected in cases where the beam incident angle is changed, and has a function to prevent irregular reflection of the information and reference beams at the reflective film of an optical recording medium to thereby prevent the occurrence of noise. Providing such a filter layer on the optical recording medium will lead to high definition and excellent diffraction efficiency.

The filter layer preferably has a function to admit light of first wavelength and reflect light of second wavelength which is different from the first wavelength, wherein first wavelength is preferably 600 nm to 900 nm, and the second wavelength is preferably 350 nm to 600 nm. To achieve this, an optical recording medium is preferable in which a recording layer, filter layer and servo pit pattern are laminated in this order from the optical system.

The filter layer preferably has an optical transmittance of 50% or more, more preferably 80% or more for light of wavelength 655 nm, and preferably has a reflectivity of 30% or more, more preferably 40% or more for light of wavelength 532 nm, both incident at an angle of within ±40°.

The filter layer is not particularly limited and can be appropriately selected depending on the intended purpose. For example, the filter layer is a laminate of a dielectric material-deposited layer, a single-layered or multilayered cholesteric liquid crystal layer, and additional layers provided on an as-needed basis. In addition, the filter layer may comprise a colored material-containing layer, and the cholesteric liquid crystal layer may be disposed thereon or the dielectric material-deposited layer may be disposed thereon.

The filter layer may be directly applied and deposited onto the support together with the recording layer. Alternatively, the filter layer may be previously deposited on a base material such as a film to prepare a filter for optical recording media, and the filter may be deposited on the support.

### —Dielectric Material-Deposited Layer—

The dielectric material-deposited layer is a laminate of multiple dielectric thin films with different refraction indices. For the dielectric material-deposited layer to serve as a reflective film through which light of desired wavelength passes, it is preferably a laminate of alternating dielectric thin films with high and low indices of refraction; however, three or more different dielectric thin films may be laminated. When the colored material-containing layer is provided, it is formed under the dielectric material-deposited layer.

The number of the dielectric thin films to be laminated is preferably 2 to 20, more preferably 2 to 12, still further preferably 4 to 10, most preferably 6 to 8. If the number of the dielectric thin films to be laminated is greater than 20, it results in the reduction in productivity because of multilayer vapor deposition. The object and effect of the invention cannot be achieved in some cases.

The order in which the dielectric thin films are laminated is not particularly limited, and can be appropriately determined depending on the intended purpose. A dielectric thin film with low refractive index is first deposited in a case where an adjacent dielectric thin film has high refractive index. On the other hand, a dielectric thin film with high refractive index is first deposited in a case where an adjacent dielectric thin film has low refractive index. The criteria of refractive index for determining whether a dielectric thin film has high or low refractive index is preferably set to 1.8; note, however, that this determination is made on an arbitrary basis. That is, dielectric thin films with different refractive indices equal to or greater than 1.8 (i.e., there are dielectric thin films with high and low refractive indices) may be used to form such a laminate.

Materials of the dielectric thin film with high refractive index are not particularly limited and can be appropriately selected depending on the intended purpose; examples thereof include Sb₂O₃, Sb₂S₃, Bi₂O₃, CeO₂, CeF₃, HfO₂, La₂O₃, Nd₂O₃, Pr₆O₁₁, Sc₂O₃, SiO, Ta₂O₅, TiO₂, TlC₁, Y₂O₃, ZnSe, ZnS and ZrO₂. Among these, Bi₂O₃, CeO₂, CeF₃, HfO₂, SiO, Ta₂O₅, TiO₂, Y₂O₃, ZnSe, ZnS and ZrO₂ are preferable, and SiO, Ta₂O₅, TiO₂, Y₂O₃, ZnSe, ZnS and ZrO₂ are more preferable.

Materials of the dielectric thin film with low refractive index are not particularly limited and can be appropriately selected depending on the intended purpose; examples thereof include Al₂O₃, BiF₃, CaF₂, LaF₃, PbCl₂, PbF₂, LiF, MgF₂, MgO, NdF₃, SiO₂, Si₂O₃, NaF, ThO₂ and ThF₄. Among these, Al₂O₃, BiF₃, CaF₂, MgF₂, MgO, SiO₂ and Si₂O₃ are preferable, and Al₂O₃, CaF₂, MgF₂, MgO, SiO₂ and Si₂O₃ are more preferable.

Note that the atomic ratio in the material for the dielectric thin film is not particularly limited and can be appropriately set depending on the intended purpose. The atomic ratio can be adjusted by changing the concentration of atmosphere's gas upon deposition of dielectric thin films.

The method for depositing the dielectric thin film is not particularly limited and can be appropriately selected depending on the intended purpose. For example, a vacuum vapor deposition process such as ion plating and ion beam, a physical vapor deposition (PVD) such as sputtering, and a chemical vapor deposition (CVD) can be used. Among these methods, a vacuum vapor deposition and sputtering are preferable, and sputtering is most preferable.

For the sputtering, DC sputtering is preferable because it offers high deposition rate. Note that highly conductive material is preferably used when DC sputtering is employed.

Examples of the method for depositing multiple dielectric thin films by sputtering include: (1) a single-chamber method, where multiple dielectric thin films are alternately or sequentially deposited using a single chamber; and (2) a multi-chamber method, where multiple dielectric thin films are sequentially deposited using multiple chambers. In view of the productivity and to prevent contamination among materials, the multi-chamber method is most preferable.

The thickness of the dielectric thin film is preferably λ/16 to λ, more preferably λ/8 to 3λ/4, most preferably λ/6 to 3λ/8 in terms of optical wavelength.

### —Colored Material-Containing Layer—

The colored material-containing layer is formed of a colored material, a binder resin, a solvent, and additional components provided on an as-needed basis.

Suitable examples of the colored material include pigments and dyes. Among these, red pigments and red dyes are preferable because they absorb light of wavelength 532 nm and admit a servo beam of wavelength 655 nm or 780 nm; red pigments are most preferable.

The red dyes are not particularly limited and can be appropriately selected from those known in the art; examples thereof include acidic dyes such as C. I. Acid Reds 1, 8, 13, 14, 18, 26, 27, 35, 37, 42, 52, 82, 87, 89, 92, 97, 106, 111, 114, 115, 134, 186, 249, 254 and 289; basic dyes such as C. I. Basic Reds 2, 12, 13, 14, 15, 18, 22, 23, 24, 27, 29, 35, 36, 38, 39, 46, 49, 51, 52, 54, 59, 68, 69, 70, 73, 78, 82, 102, 104, 109 and 112; and reactive dyes such as C. I Reactive Reds 1, 14, 17, 25, 26, 32, 37, 44, 46, 55, 60, 66, 74, 79, 96 and 97. These dyes may be used singly or in combination.

The red pigments are not particularly limited and can be appropriately selected from those known in the art; examples thereof include C. I. Pigment Red 9, C. I. Pigment Red 97, C. I. Pigment Red 122, C. I. Pigment Red 123, C. I. Pigment Red 149, C. I. Pigment Red 168, C. I. Pigment Red 177, C. I. Pigment Red 180, C. I. Pigment Red 192, C. I. Pigment Red 209, C. I. Pigment Red 215, C. I. Pigment Red 216, C. I. Pigment Red 217, C. I. Pigment Red 220, C. I. Pigment Red 223, C. I. Pigment Red 224, C. I. Pigment Red 226, C. I. Pigment Red 227, C. I. Pigment Red 228, C. I. Pigment Red 240, C. I. Pigment Red 48:1, Permanent Carmine FBB (C. I. Pigment Red 146), Permanent Ruby FBH (C. I. Pigment Red 11) and Faster Pink B Supra (C. I. Pigment Red 81). These pigments may be used singly or in combination.

Among these red pigments, those with an optical transmittance of 10% or less for light of wavelength 532 nm and 90% or more for light of wavelength 655 nm are most preferably used.

The content of the colored material is preferably 0.05% by mass to 90% by mass, more preferably 0.1% by mass to 70% by mass of the total solid components of the colored material-containing layer. If the content of the colored material is less than 0.05% by mass, the thickness of the colored material-containing layer may need to be set to 500 μm or more. If the content of the colored material is greater than 90% by mass, the colored material-containing layer may collapse during its preparation due to lack of self-supporting properties.

### —Binder Resin—

The binder resin is not particularly limited and can be appropriately selected from those known in the art; examples thereof include polyvinylalcohol resins; vinyl chloride/vinyl acetate copolymers; copolymers of vinyl chloride or vinyl alcohol and at least one of malleic acid and acrylic acid; vinyl chloride/vinylidene chloride copolymers; vinyl chloride/acrylonitrile copolymers; ethylene/vinyl acetate copolymers; celluloses derivatives such as nitrocellulose resins; polyacrylic resins; polyvinylacetal resins; polyvinylbutyral resins; epoxy resins; phenoxy resins; polyurethane resins; and polycarbonate resins. These materials can be used singly or in combination.

In addition, polar groups (e.g., epoxy group, CO₂H, OH, NH₂, SO₃M, OSO₃M, PO₃M₂, and OPO₃M₂, where M represents a hydrogen atom, alkali metal, or ammonium and if two or more M's appear, they may be different) are preferably introduced into the molecules of the above-listed binder resins in order to increase their dispersibility and durability. The content of such polar groups is preferably 10⁻⁶ to 10⁻⁴ equivalents per gram of binder resin.

The binder resins are preferably cured by the addition of a known isocyanate crosslinking agent.

The content of the binder resin is preferably 10% by mass to 99.5% by mass, more preferably 30% by mass to 99.9% by mass of the total solid components of the colored material-containing material.

These components described above are dissolved or dispersed in a suitable solvent to prepare a coating solution, and the coating solution is applied over a base material to be described later using a desired coating method. In this way a colored material-containing layer can be formed.

The solvent is not particularly limited and can be appropriately selected from those known in the art; examples thereof include water; alkoxypropionates such as methyl 3-methoxypropionate, ethyl 3-methoxypropionate, propyl 3-methoxypropionate, methyl 3-ethoxypropionate, ethyl 3-ethoxypropionate and propyl 3-ethoxypropionate; alkoxy alcohol esters such as 2-methoxypropylacetate, 2-ethoxypropylacetate and 3-methoxybutylacetate; lactates such as methyl lactate and ethyl lactate; ketones such as methyl ethyl ketone, cyclohexanone and methylcyclohexanone; γ-butyrolactone; N-methylpyrrolidone; dimethylsulfoxide; chloroform; and tetrahydrofuran. These solvents may be used singly or in combination.

The coating method is not particularly limited and can be appropriately selected from those known in the art depending on the intended use; examples thereof include an ink-jetting, spin coating, kneader coating, bar coating, blade coating, casting, dipping, and curtain coating.

The thickness of the colored material-containing layer is preferably 0.5 μm to 200 μm, more preferably 1.0 μm to 100 μm, for example. If the thickness of the colored material-containing layer is less than 0.5 μm, binder resin that encapsulates colored material to form a film cannot be added in sufficient amounts in some cases. If the thickness of the colored material-containing layer is greater than 200 μm, the resultant filter is made too thick, thus requiring a big optical system for an irradiating beam and servo beam in some cases.

### <Cholesteric Liquid Crystal Layer>

The cholesteric liquid crystal layer contains at least cholesterol derivative, or a nematic liquid crystal compound and a chiral compound, and further contains a polymerizable mononer, and additional component(s) on as-needed basis.

The cholesteric liquid crystal layer may be either a single-layered cholesteric liquid crystal layer or a multilayered cholesteric liquid crystal layer.

The cholesteric liquid crystal layer preferably has a circularly polarizing function. The cholesteric liquid crystal layer selectively reflects light components which have been circularly polarized in the direction in which the liquid crystal helix rotates (i.e., to the right or left) and which have a wavelength that equals to the pitch of the liquid crystal helix. The cholesteric liquid crystal layer utilizes the selective reflection characteristics to separate a particular circularly polarized component of a particular wavelength from natural light of different wavelengths, and blocks the other light components.

The filter for optical recording media preferably has a reflectivity of 40% or more for light of a wavelength range of λ₀ to λ₀/cos 20° (where λ₀ represents the wavelength of irradiation light) incident at an angle of ±20° (measured from the normal of the surface of the recording layer). Most preferably, the filter for optical recording media has a reflectivity of 40% or more for light of a wavelength range of λ₀ to λ₀/cos 40° (where λ₀ represents the wavelength of irradiation light) incident at an angle of ±40° (measured from the normal of the surface of the recording layer). If the optical reflectivity is 40% or more for light of a wavelength range of λ₀ to λ₀/cos 20°, especially λ₀ to λ₀/cos 40° (where λ₀ represents the wavelength of irradiation light), it is made possible to eliminate the dependency of reflectivity on incident angle and to adopt optical lens system that is used for general optical recording media. For this purpose, the cholesteric liquid crystal layer preferably has a large selectively-reflecting wavelength range.

More specifically, when a single-layer cholesteric liquid crystal layer is used, the selectively-reflecting wavelength range Δλ is expressed by the following Equation (1) and thus it is preferable to use liquid crystal with large (ne−no):

Δλ=2λ(ne−no)/(ne+no) Equation (1)

where “no” represents the refractive index of the nematic liquid crystal molecules for normal light, contained in the cholesteric liquid crystal layer, “ne” represents the refractive index of the nematic liquid crystal molecules for abnormal light, and λ represents the central wavelength of light selectively reflected.

As described in Japanese Patent Application No. 2004-352081, it is preferable to use photoreactive chiral compounds whose helical pitch can be largely altered by irradiation with light and to use a filter for optical recording medium in which helical pitch is continuously changed in the thickness direction of the liquid crystal layer by adjusting the content of the photoreactive chiral compound and UV irradiation time.

In the case of a multilayered cholesteric liquid crystal layer, cholesteric liquid crystal layers with different λ values, where the helices rotate to the same direction, are preferably laminated.

The cholesteric liquid crystal layer is not particularly limited as long as it has the foregoing characteristics, and can be appropriately selected depending on the intended purpose. As described above, the cholesteric liquid crystal layer contains a nematic liquid crystal compound and a chiral compound, and further contains a polymerizable monomer, and additional component(s) on as-needed basis.

### —Nematic Liquid Crystal Compounds—

The nematic liquid crystal compounds features that their liquid crystal phase solidifies under the liquid crystal transition temperature, and can be appropriately selected from liquid crystal compounds, high-molecular liquid crystal compounds and polymerizable liquid crystal compounds, all of which have refractive index anisotropy Δn of 0.10 to 0.40. For example, such nematic liquid crystal compound molecules that are in the liquid crystal state by treatment with heat can be aligned by use of a surface-rubbed alignment substrate, followed by a cooling treatment or the like to allow them to be immobilized to the substrate to serve as a solid article.

The nematic liquid crystal compound is not particularly limited and can be appropriately selected depending on the intended purpose. Nematic liquid crystal compounds that have polymerizable groups in their molecule are preferable for the purpose of ensuring sufficient curing capability, and ultraviolet (UV) polymerizable liquid crystal compounds are suitably used. Examples of such ultraviolet (UV) polymerizable liquid crystal compounds include the following commercially available products: PALIOCOLOR LC242 (bland name, produced by BASF Corp.); E7 (bland name, produced by Merck Ltd.); LC-Silicon-CC3767 (bland name, produced by Wacker-Chem); and L35, L42, L55, L59, L63, L79 and L83 (bland name, produced by Takasago International Corp.).

The content of the nematic liquid crystal compound is preferably 30% by mass to 99% by mass, more preferably 50% by mass to 99% by mass of the total solid components in each of the cholesteric liquid crystal layer. If the content of the nematic liquid crystal compound is less than 30% by mass, it may result in poor alignment of nematic liquid crystal molecules.

### —Chiral Compounds—

In the case of a multilayered cholesteric liquid crystal layer, the chiral compound is not particularly limited and can be appropriately selected from those known in the art; in view of the hues of the liquid crystal compounds and for enhanced color purity, for example, isomannide compounds, catechine compounds, isosorbide compounds, fenchone compounds and carvone compounds can be used. These chiral compounds may be used singly or in combination.

In addition, commercially available chiral compounds can also be used; examples thereof include S101, R811 and CB15 (bland name, produced by Merck Ltd.); and PALIOCOLOR LC756 (bland name, produced by BASF Corp.).

The content of the chiral compound in each liquid crystal layer of the multilayered cholesteric liquid crystal layer is preferably 30% by mass or less, more preferably 20% by mass or less of the total solid components in each liquid crystal layer. If the content of the chiral compound is greater than 30% by mass, it may result in poor alignment of cholesteric liquid crystal molecules.

### —Polymerizable Monomer—

It is also possible to add a polymerizable monomer to the cholesteric liquid crystal layer in order to, for example, increase the degree of cure in the layer (e.g., layer strength). Combined use of a polymerizable monomer can increase the strength of the cholesteric liquid crystal layer, where different twisting degrees have been set for liquid crystals through which light propagates (e.g., the distribution of wavelengths of light to be reflected has been created) and where the helical structure (i.e., selective reflection capability) has been fixed. Note, however, that such a polymerizable monomer needs not necessarily be added if the liquid crystal compound bears polymerizable groups in its molecule.

The polymerizable monomer is not particularly limited and can be appropriately selected from those known in the art; examples thereof include monomers bearing ethylenically unsaturated bonds, and specific examples of such monomers include multifunctional monomers such as pentaerythritoltetraacrylate and dipentaerythritolhexaacrylate. These monomers can be used singly or in combination.

The content of the polymerizable monomers is preferably 50% by mass or less, more preferably 1% by mass to 20% by mass of the total solid components in the cholesteric liquid crystal layer. If the content of the polymerizable monomers is greater than 50% by mass, it may inhibit the alignment of cholesteric liquid crystal molecules.

### —Additional Components—

The additional components are not particularly limited and can be appropriately selected depending on the intended purpose; examples thereof include photoinitiators, sensitizers, binder resins, polymerization inhibitors, solvents, surfactants, thickeners, dyes, pigments, ultraviolet absorbers and gelling agents.

The photoinitiators are not particularly limited and can be appropriately selected from those known in the art; examples thereof include p-methoxyphenyl-2,4-bis(trichloromethyl)-s-triazine, 2-(p-buthoxystyryl)-5-trichloromethyl-1,3,4-oxadiazole, 9-phenylacridine, 9,10-dimethylbenzphenazine, benzophenone/Michler's ketone, hexaarylbiimidazole/mercaptobenzoimidazole, benzyldimethylketal, acylphosphine derivatives, and thioxanthone/amine. These photoinitiators may be used singly or in combination.

In addition, commercially available photoinitiators can also be used; examples thereof include IRGA CURE 907, IRGA CURE 369, IRGA CURE 784 and IRGA CURE 814 (bland name, produced by Ciba Specialty Chemicals); and Lucirin TPO (bland name, produced by BASF Corp.).

The content of the photoinitiator is preferably 0.1% by mass to 20% by mass, more preferably 0.5% by mass to 5% by mass of the total solid components in the cholesteric liquid crystal layer. If the content of the photoinitiator is less than 0.1% by mass, it may take long time for the polymerization because of reduced curing efficiency upon irradiation with light. If the content of the photoinitiator is greater than 20% by mass, it may result in poor optical transmittance over the spectrum from ultraviolet to visible light.

The sensitizer can be added on an as-needed basis in order to increase the degree of cure in the cholesteric liquid crystal layer.

The sensitizer is not particularly limited and can be appropriately selected from those known in the art; examples thereof include diethylthioxanthone and isopropylthioxanthone.

The content of the sensitizer is preferably 0.001% by mass to 1.0% by mass of the total solid components in the cholesteric liquid crystal layer.

The binder resin is not particularly limited and can be appropriately selected from those known in the art; examples thereof include polyvinyl alcohols; polystyrene compounds such as polystyrene and poly-α-methylstyrene; cellulose resins such as methylcellulose, ethylcellulose and acetylcellulose; acid cellulose derivatives bearing carboxylic groups on their side chains; acetal resins such as polyvinyl formal and polyvinyl butyral; methacrylic acid copolymers; acrylic acid copolymers; itaconic acid copolymers; crotonic acid copolymers; malleic acid copolymers; partially-esterified malleic acid copolymers; homopolymers of acrylic acid alkylesters or homopolymers of methacrylic acid alkyl esters; and polymers with additional hydroxyl groups. These binder resins may be used singly or in combination.

Examples of alkyl groups in the homopolymers of acrylic acid alkylesters or homopolymers of methacrylic acid alkyl esters include methyl group, ethyl group, n-propyl group, n-butyl group, iso-butyl group, n-hexyl group, cyclohexyl group and 2-ethylhexyl group.

Examples of the polymers with additional hydroxyl groups include benzyl(meth)acrylate/(homopolymers of methacrylic acid) acrylic acid copolymers, and multicomponent copolymers of benzyl(meth)acrylate/(meth)acrylic acid/other monomers.

The content of the binder resin is preferably 80% by mass or less, more preferably 50% by mass or less of the total solid components in the cholesteric liquid crystal layer. If the content of the binder resin is greater than 80% by mass, it may result in poor alignment of cholesteric liquid crystal molecules.

The polymerization inhibitor is not particularly limited and can be appropriately selected depending on the intended purpose; examples thereof include hydroquinones, hydroquinone monomethylethers, phenothiazines, benzoquinones and derivatives thereof.

The content of the polymerization inhibitor is preferably 10% by mass or less, more preferably 0.01% by mass to 1% by mass of the total solid components in the polymerizable monomers.

The solvent is not particularly limited and can be appropriately selected from those known in the art; examples thereof include alkoxypropionates such as methyl 3-methoxypropionate, ethyl 3-methoxypropionate, propyl 3-methoxypropionate, methyl 3-ethoxypropionate, ethyl 3-ethoxypropionate and propyl 3-ethoxypropionate; alkoxy alcohol esters such as 2-methoxypropylacetate, 2-ethoxypropylacetate and 3-methoxybutylacetate; lactates such as methyl lactate and ethyl lactate; ketones such as methyl ethyl ketone, cyclohexanone and methylcyclohexanone; γ-butyrolactone; N-methylpyrrolidone; dimethylsulfoxide; chloroform; and tetrahydrofuran. These solvents may be used singly or in combination.

The cholesteric liquid crystal layer can be formed in the following procedure: For example, a coating solution for cholesteric liquid crystal layer prepared by use of the solvent is applied on the base material (note that this coating solution is prepared for each liquid crystal layer in the case of a multilayered cholesteric liquid crystal layer). Thereafter, the coating solution is dried, and cured by irradiating it with ultraviolet light.

For mass production, the cholesteric liquid crystal layer can be formed in the following procedure: The base material is previously wound in a roll shape, and the coating solution is then applied on the base material using a long, continuous coater such as a bar coater, die coater, blade coater, or curtain coater.

Examples of the coating method include a spin coating method, casting, roll coating, flow coating, printing, dip coating, casting deposition, bar coating, and gravure printing.

The UV irradiation condition is not particularly limited and can be appropriately determined depending on the intended purpose; the wavelength of UV light to be applied is preferably 160 nm to 380 nm, more preferably 250 nm to 380 nm; irradiation time is preferably 0.1 seconds to 600 seconds, more preferably 0.3 second to 300 seconds. By adjusting the UV irradiation condition, it is possible to change the helical pitch in the cholesteric liquid crystal layer, in which the photoreactive chiral compound is used, continuously in the thickness direction of the liquid crystal layer.

It is also possible to add an ultraviolet absorber to the cholesteric liquid crystal layer in order to adjust the UV irradiation condition. The ultraviolet absorber is not particularly limited and can be appropriately selected depending on the intended purpose; suitable examples thereof include benzophenone ultraviolet absorbers, benzotriazole ultraviolet absorbers, salicylic acid ultraviolet absorbers, cyanoacrylate ultraviolet absorbers and oxalic acid anilide ultraviolet absorbers. Specific examples of these ultraviolet absorbers are disclosed in JP-A Nos. 47-10537, 58-111942, 58-212844, 59-19945, 59-46646, 59-109055 and 63-53544; JP-B Nos. 36-10466, 42-26187, 48-30492, 48-31255, 48-41572, 48-54965, and 50-10726; and U.S. Pat. Nos. 2,719,086, 3,707,375, 3,754,919 and 4,220,711.

In the case of a multilayered colesteric liquid crystal layer, the thickness of each cholesteric liquid crystal layer is preferably 1 μm to 10 μm, more preferably 2 μm to 7 μm. If the thickness of the cholesteric liquid crystal layer is less than 1 μm, it results in poor selective reflectivity. If the thickness of the cholesteric liquid crystal layer is greater than 10 μm, uniformly aligned liquid crystal molecules in the cholesteric liquid crystal layer may orient in random directions.

The total thickness of the cholesteric liquid crystal layer in a multilayered cholesteric liquid crystal layer (or the thickness of a single-layered liquid crystal layer) is preferably 1 μm to 30 μm, more preferably 3 μm to 10 μm.

### <The Production Process for a Filter for Optical Recording Medium which has a Colesteric Liquid Crystal Layer>

The process for producing the filter is not particularly limited and can be appropriately selected depending on the intended purpose.

The filter for optical recording media is not particularly limited and can be appropriately selected depending on the intended purpose. The filter is preferably processed into a disc-shape together with a base material through, for example, a stamping process, and is preferably disposed on the second substrate of an optical recording medium. Alternatively, the filter can be directly disposed on the second substrate without interposing a base material between them in a case where the filter is intended to be used for the filter layer of the optical recording medium.

### <Base Material>

The base material is not particularly limited and can be appropriately selected depending on the intended purpose. The base material may be either a freshly prepared one or a commercially available one.

The thickness of the base material is not particularly limited and can be appropriately set depending on the intended purpose; the thickness is preferably 10 μm to 500 μm, more preferably 50 μm to 300 μm. If the thickness of the base material is less than 10 μm, the substrate bends and thus its adhesion properties with other components are reduced. If the thickness of the base material is greater than 500 μm, the focus of information light needs to be shifted by a large amount from the focus of reference light, leading to the necessity of preparing a big optical system. For bonding a film through which light of desired wavelength passes, known adhesives can be used in any combination.

The adhesive is not particularly limited and can be appropriately selected depending on the intended purpose; examples thereof include UV curable adhesives, emulsion adhesives, one-component curable adhesives and two-component curable adhesives. These known adhesives can be used in any combination.

The agglutinant is not particularly limited and can be appropriately selected depending on the intended purpose; examples thereof include rubber agglutinants, acrylic agglutinants, silicone agglutinants, urethane agglutinants, vinylalkyl ether agglutinants, polyvinylalcohol agglutinants, polyvinylpyrrolidone agglutinants, polyacrylamide agglutinants and cellulose agglutinants.

The thickness of the adhesive or agglutinant applied is not particularly limited and can be appropriately set depending on the intended purpose. In the case of adhesive, the thickness is preferably 0.1 μm to 10 μm, more preferably 0.1 μm to 5 μm in light of the optical characteristics and slimness. In the case of agglutinant, the thickness is preferably 1 μm to 50 μm, more preferably 2 μm to 30 μm.

Note, however, that it is possible to directly form the filter layer on the substrate depending on the circumstances.

### <Additional Layer>

The additional layer is not particularly limited and can be appropriately selected; examples are a first gap layer, a second gap layer, an antireflection layer, and a protective layer.

### —First Gap Layer—

The first gap layer is provided between the filter layer and the reflective film on an as-needed basis for smoothing the surface of the second substrate. Moreover, the first gap layer is effective to adjust the size of holograms formed in the recording layer. Specifically, since somewhat large regions where optical interference between an information beam and recording reference beam takes place need to be secured in the recording layer, it is effective to provide the first gap layer between the recording layer and the servo pit pattern.

The first gap layer can be formed by, for example, applying UV curable resin or the like on the servo pit pattern by spin coating or the like and by curing the resin. In addition, when a filter layer is formed on a transparent base material, the transparent base material also serves as the first gap layer.

The thickness of the first gap layer is not particularly limited and can be appropriately set depending on the intended purpose; the thickness is preferably 1 μm to 200 μm.

### —Second Gap Layer—

The second gap layer is provided between the recording layer and the filter layer on an as-needed basis.

Materials of the second gap layer are not particularly limited and can be appropriately selected depending on the intended purpose; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (bland name, produced by JSR Corp.), ZEONOA (bland name, produced by Nippon Zeon). Among these, those with high isotropy are preferable, and TAC, PC, ARTON and ZEONOA are most preferable.

The thickness of the second gap layer is not particularly limited and can be appropriately set depending on the intended purpose; the thickness is preferably 1 μm to 200 μm.

### (Method for Manufacturing Optical Recording Medium)

The method used in the present invention for manufacturing the optical recording medium of the present invention includes a composition preparation step, a recording layer deposition step, a filter layer formation step, a first gap layer formation step, and a laminate formation step, and where necessary, further includes additional step(s).

### <Composition Preparation Step>

The composition preparation step is directed to prepare an optical recording composition. In this step an optical recording composition that contains a photopolymer consisting of a monomer, a photoinitiator, a sensitizer, an oligomer, a binder, etc., and where necessary, additional component(s) appropriately selected is dissolved or dispersed in, or mixed with, a solvent. The condition used for preparation is as follows: temperature=23° C., humidity=10%, a low-temperature, dry environment.

### <Recording Layer Formation Step>

The recording layer formation step is directed to deposit a recording layer, a layer that records therein information by holography, onto the filter layer, or where a second gap layer is deposited on the filter layer, onto the second gap layer. In this step the optical recording composition prepared by the composition preparation step is deposited onto either of the foregoing layers by coating.

The method of recording layer deposition is not particularly limited and can be appropriately determined depending on the intended purpose; for example, a wet film deposition method, an injection method or the like can be employed. The wet film deposition method can be suitably performed by using a coating solution containing a recording layer material dissolved in a solvent (i.e., by applying the coating solution on a layer to be coated and drying it). The wet deposition method is not particularly limited and can be appropriately selected from those known in the art depending on the intended use; examples thereof include an ink-jetting, spin coating, kneader coating, bar coating, blade coating, casting, dipping, and curtain coating.

The injection method is directed to inject a recording layer solution between the first and second substrates. An outer circumferential spacer and an inner circumferential spacer are previously inserted between the first and second substrates to fabricate a disc cell, the outer circumferential spacer is notched, forming an inlet through which a recording layer solution is injected into the disc cell.

The method of injection is not particularly limited and can be appropriately selected depending on the intended purpose; for example, an outer circumference injection method, an inner circumference injection method, or a gap injection method can be used.

An example of the injection condition is as follows: temperature=23° C., viscosity=330 mPa·s, pressure=0.5 Mpa, humidity=10%, curing time=40 minutes, curing temperature=80° C.

An injection device to be employed is not particularly limited and can be appropriately selected depending on the intended purpose; for example, a syringe, an air-operated dispenser or the like can be used.

The thickness of the recording layer is not particularly limited and can be appropriately set depending on the intended purpose; the thickness of the recording layer is preferably 1 μm to 1,000 μm, more preferably 100 μm to 700 μm.

If the thickness of the recording layer is within a preferable range, it will result in excellent S/N ratios even when 10- to 300-fold shift-multiplexing recording operation is performed; more excellent S/N ratios can be obtained in a more preferable thickness range.

### —Outer Circumferential Spacer—

The shape of the outer circumferential spacer is not particularly limited as long as the outer circumference thereof is almost the same as the outer circumferential shape of optical recording medium, and can be appropriately selected depending on the intended purpose; examples thereof include quadrangle, circle, ellipse, and polygon. Among these, circle is preferable.

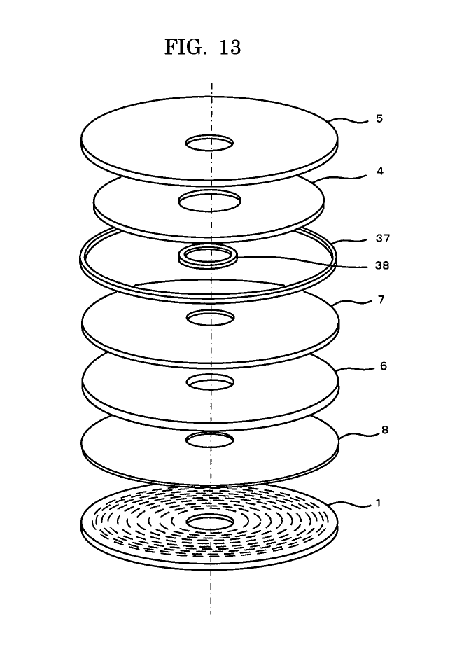

Examples of the cross-sectional shape of the outer circumferential spacer include quadrangle, rectangle, trapezoid, circle, and ellipse. Among these, quadrangle, trapezoid, and rectangle are preferable for achieving constant thickness. The spacer shown in FIG. 13 is an example of the spacer with a quadrangular cross-sectional shape.

The thickness of the outer circumferential spacer is not particularly limited and can be appropriately set depending on the intended purpose. For example, the outer circumferential spacer preferably has almost the same thickness as that of the recording layer, specifically, 100 μm to 1,000 μm.

The width of the outer circumferential spacer is not particularly limited as long as it is at least 0.5 mm and can be appropriately set depending on the intended purpose. For example, the width of the outer circumferential spacer is preferably 0.5 mm to 5 mm, more preferably 0.5 mm to 3 mm, most preferably 0.5 mm to 2 mm. If the width is less than 0.5 mm, a retaining function for making the thickness of the recording layer constant may be deteriorated due to a reduced mechanical strength or supporting area. If the width is more than 5 mm, holographic recording region is narrowed, and storage capacity may be reduced.

Materials of the outer circumferential spacer are not particularly limited, and inorganic and organic materials can be suitably used; however, organic materials are preferable in view of their formability.

Examples of the inorganic materials include glass, ceramic, quartz and silicon.

The organic materials are not particularly limited and can be appropriately selected depending on the intended purpose. Examples of the organic materials include acetate resins such as triacetylcellulose, polyester resins, polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinylalcohol resins, polyvinyl chloride resins, polyvinylidene chloride resins, and polyacrylic resins. These may be used singly or in combination. Among these, polycarbonate resins and acrylic resins are preferable in light of their formability, peeling properties, and costs.

The method for producing the spacer is not particularly limited and can be appropriately selected depending on the intended purpose; examples thereof include injection molding, blow molding, compression molding, vacuum molding, extrusion molding, and cutting machining.

### —Inner Circumferential Spacer—

The shape of the inner circumferential spacer is not particularly limited as long as the inner circumference thereof is almost the same as the shape of the opening which the optical recording medium is provided with, and can be appropriately selected depending on the intended purpose; examples thereof include quadrangle, circle, ellipse, and polygon. Among these, circle is preferable.

Preferably, the cross-sectional shape of the inner circumferential spacer is the same as that of the outer circumferential spacer; examples thereof include quadrangle, rectangle, trapezoid, circle, and ellipse. Among these, quadrangle, trapezoid, and rectangle are preferable for achieving constant thickness.

The thickness of the inner circumferential spacer is required to be the same as that of the outer circumferential spacer in terms of the uniformity of the thickness of the recording layer.

The width of the inner circumferential spacer may be the same as or different from that of the outer circumferential spacer in terms of function to retain the uniformity of the thickness of the recording layer and in terms of ensuring the recording region of the recording layer. Materials of the inner circumferential spacer and the production method of the inner circumferential spacer may be or may not be identical to those of the outer circumferential spacer.

### <Filter Layer Formation Step>

The filter layer formation step is a step in which the filter for optical recording medium of the invention is processed into the optical recording medium shape, and the processed filter is bonded to the second substrate to form a filter layer. The process for producing the filter for the optical recording medium of the invention is as described above. Note, however, that it is possible to directly form the filter layer on the substrate depending on the circumstances. For example, a coating solution for colored material-containing layer is applied onto the substrate to form a colored material-containing layer, and a dielectric thin film is formed on the colored material-containing layer by sputtering.

The shape of the optical recording medium is, for example, disc shape or card-like shape. The method for processing the filter into the optical recording medium shape is not particularly limited, and can be appropriately selected depending on the intended purpose. For example, a cutting process with a press cutter, or a stamping process with a stamping cutter can be used. The filter is bonded to the substrate by use of, for example, an adhesive or agglutinant while avoiding entry of air bubbles.

The adhesive is not particularly limited and can be appropriately selected depending on the intended purpose; examples thereof include UV curable adhesives, emulsion adhesives, one-component curable adhesives and two-component curable adhesives. These known adhesives can be used in any combination.

The agglutinant is not particularly limited and can be appropriately selected depending on the intended purpose; examples thereof include rubber agglutinants, acrylic agglutinants, silicone agglutinants, urethane agglutinants, vinylalkyl ether agglutinants, polyvinylalcohol agglutinants, polyvinylpyrrolidone agglutinants, polyacrylamide agglutinants and cellulose agglutinants.

The thickness of adhesive or agglutinant coating is not particularly limited and can be appropriately set depending on the intended purpose. In the case of adhesive, the thickness is preferably 0.1 μm to 10 μm, more preferably 0.1 μm to 5 μm in light of the optical characteristics and slimness. In the case of agglutinant, the thickness is preferably 1 μm to 50 μm, more preferably 2 μm to 30 μm.

### <First Gap Layer Formation Step>

The gap layer formation step is a step in which a gap layer is formed between the second substrate and the filter layer. The method for forming the gap layer is not particularly limited and can be appropriately selected depending on the intended purpose. The gap layer can be formed on the second substrate by means of spin coating, a method of bonding a sheet member, vapor deposition, sputtering, or the like.

### <Laminate Formation Step>

The laminate formation step is a step in which the first substrate is bonded to the second substrate over which the recording layer, the filter layer and gap layer have been formed by the recording layer depositing step, the filter layer formation step and the gap layer formation step, to form a laminate. Where necessary, the laminate formation step may comprise additional step(s) selected appropriately.

The method for bonding is not particularly limited and can be appropriately selected depending on the intended purpose. For example, the first substrate, the second substrate and additional layer(s) are bonded together with an adhesive; or bonded together by application of pressure without using any adhesive; or bonded together in vacuum.

The method for bonding with an adhesive is carried out as follows: The edges the first substrate, second substrate and additional layer(s) are aligned, an adhesive is applied between each of the layers and bonded together at 23° C. to 100° C. with an external pressure of 0.01 MPa to 0.5 MPa.

Bonding is preferably performed in vacuum so as to avoid generation of air bubbles during bonding.

### —Adhesive—

The adhesive is not particularly limited and can be appropriately selected depending on the intended purpose; examples thereof include acrylic adhesives, epoxy adhesives, and rubber adhesives.

Among these, acrylic adhesives and epoxy adhesives are preferable in view of their transparency, etc.

The method for pressure bonding without using any adhesive can be carried out by allowing layers to adhere to each other utilizing adhesiveness of each layer, to form a laminate: The edges of the first substrate, second substrate, and additional layers are aligned and bonded together at 23° C. to 100° C. with an external pressure of 0.01 MPa to 0.5 MPa. Bonding for adhesion is preferably performed in vacuum so as to avoid entry of air bubbles during adhesion.

### <Additional Step>

The additional step is not particularly limited and can be appropriately selected depending on the intended purpose; examples thereof include a second gap layer formation step of forming a second gap layer between the recording layer and filter layer, and a side-surface sealing step of sealing the side surface of the optical recording medium with an adhesive.

### <Specific Example 1 of the Optical Recording Medium>

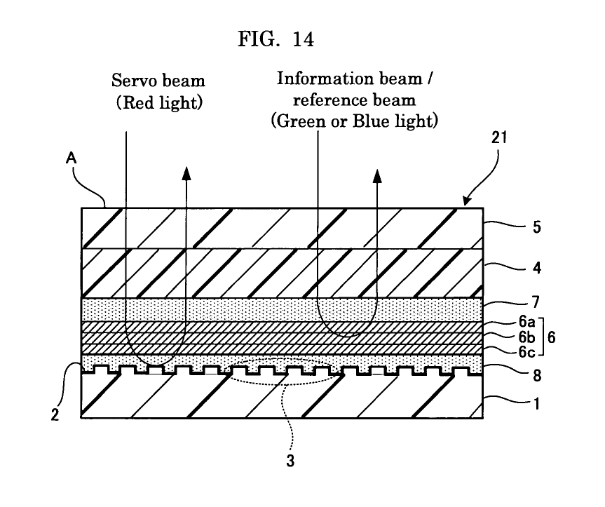

FIGS. 12 and 14 are schematic cross-sectional views each showing the structure of the optical recording medium in Specific Example 1 of the present invention. In an optical recording medium 21 according to Specific Example 1 a servo pit pattern 3 is formed on a second substrate 1 made of polycarbonate resin or glass, and the serve pit pattern 3 is coated with Al, Au, Pt or the like to form a reflective film 2. Although the servo pit pattern 3 is formed on the entire surface of the second substrate 1 in FIG. 14, it may be formed on the second substrate 1 periodically as shown in FIG. 10. In addition, the height of the servo pit pattern 3 is generally 1750 angstrom (175 nm), far smaller than those of the other layers, including substrates.

A first gap layer 8 is formed by applying UV curable resin or the like on the reflective film 2 of the second substrate 1 by spin coating or the like. The first gap layer 8 is effective for protecting the reflective film 2 and for adjusting the size of holograms created in a recording layer 4. Specifically, since somewhat large regions where optical interference between an information beam and recording reference beam takes place need to be secured in the recording layer 4, it is effective to provide clearance between the recording layer 4 and the servo pit pattern 3.

A filter layer 6 is provided on the first gap layer 8, and the recording layer 4 is sandwiched between the filter layer 6 and a first substrate (a polycarbonate resin substrate or glass substrate) to constitute the optical recording medium 21.

In FIG. 14 the filter layer 6 admits only red light and reflects light of the other colors. Therefore, the information beam and recording and reproduction beams do not pass through the filter layer 6 because they are green or blue light, and never reach the reflective film 2, becoming returning beams emitting from the light entrance/exit surface A.

The filter layer 6 is constituted of a single-layered cholesteric liquid crystal layer whose helical pitch is continuously changed in the thickness direction thereof. The filter layer 6 may be directly provided on the first gap layer 8 with a coating method, or may be provided by stamping a film in which a cholesteric liquid crystal layer is formed on a base material into the optical disc shape. By using such a single-layered cholesteric liquid crystal layer, optical transmittance of 40% or more can be realized for light of a wavelength range of λ₀ to λ₀/cos 20°, especially λ₀ to λ₀/cos 40° (where λ₀ represents the wavelength of a beam of light applied), thereby eliminating the fluctuations in the selectively-reflecting wavelength range even when the incident angle has changed.

The optical recording medium 21 of Specific Example 1 may be of disc shape or card-like shape. There is no need to provide a servo pit pattern in a case where the optical recording medium 21 is of card-like shape. In the optical recording medium 21 the second substrate 1 is 0.6 mm in thickness, the first gap layer 8 is 100 μm in thickness, the filter layer 6 is 2 μm to 3 μm in thickness, the recording layer 4 is 0.6 mm in thickness, and the first substrate 5 is 0.6 mm in thickness, bringing to the total to about 1.9 mm.

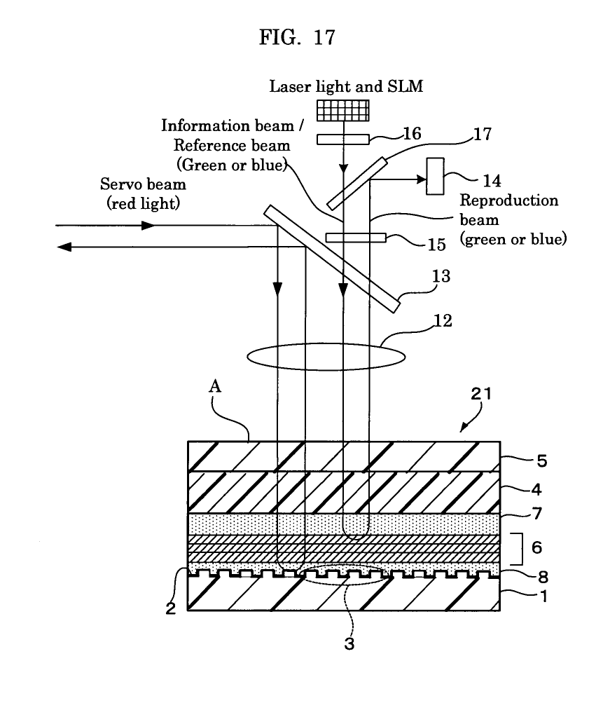

Next, optical operations around the optical recording medium 21 will be described with reference to FIG. 17.

First, a red light beam emitted from the servo laser source is reflected by a dichroic mirror 13 by almost 100%, and passes through an objective lens 12. By this, the servo beam is applied onto the optical recording medium 21 in such a way that it focuses on the reflective film 2. More specifically, the dichroic mirror 13 is so configured that it admits only green or blue light but reflects almost 100% of red light. The servo beam incident from the light entrance/exit surface A of the optical recording medium 21 passes through the first substrate 5, recording layer 4, filter layer 6 and first gap layer 8, is reflected by the reflective film 2, and passes again through the first gap layer 8, filter layer 6, recording layer 4 and first substrate 5 to emit from the light entrance/exit surface A. The returning servo beam passes through the objective lens 12 and is reflected by the dichroic mirror by almost 100%, and then a servo information detector (not shown) detects servo information in the returning servo beam. The detected servo information is used for the focus servo operation, tracking servo operation, slide servo operation, and the like. The holographic material constituting the recording layer 4 is designed so as not to be sensitive to red light. For this reason, even when the servo beam has passed through the recording layer 4 or has been reflected diffusively by the reflective film 2, the recording layer 4 is not adversely affected. In addition, the returning servo beam that has been reflected by the reflective film 2 is reflected by the dichroic mirror 13. Accordingly, the servo beam is not detected by a CMOS sensor or CCD 14 used for the detection of reconstructed images, and thus does not interfere with the operation of a reproduction beam.

Note that with respect to the reflection range of λ₀ to 1.3λ₀, 1.3λ₀ shown in FIG. 16, 1.3λ₀ equals to 692 nm when λ₀ is 532 nm, and thus a servo beam of wavelength 655 nm is undesirably reflected. This reflection range is set in view of light incident at an angle of ±40°. However, when such light that is incident at larger angles is intended to be used, a servo operation can be performed without causing any problems by using a servo beam incident at an angle of within ±20° that has been masked. In addition, by securing larger helical pitch in the cholesteric liquid crystal layer in the filter layer used, it is also possible to readily cover a servo beam incident to the filter layer at an angle of within ±90°. In that case, it is only necessary to prepare a cholesteric liquid crystal layer with a reflection range of λ₀ to 1.1λ₀. Thus, transmittance of the servo beam entails no difficulty.

Both the information beam and recording reference beam generated in the recording/reproduction laser source pass through a polarizing plate 16 and are linearly polarized. The linearly polarized beams then pass through a half mirror 17 and are circularly polarized after passing through a quarter wave plate 15. The circularly polarized beams then pass through the dichroic mirror 13 and the objective lens 12, and are applied onto the optical recording media 21 in such a way that optical interference takes place between the information beam and recording reference beam to create interference images in the recording layer 4. The information beam and recording reference beam are incident from the light entrance/exit surface A and interact with each other in the recording layer 4 to form an interference image to be recorded there. Thereafter, the information beam and recording reference beam pass through the recording layer 4, launching into the filter layer 6. There, before reaching the bottom of the filter layer 6, the beams are reflected and become returning beams. More specifically, the information beam and recording reference beam do not reach the reflective film 2. This is because the filter layer 6 is formed of a single-layered cholesteric liquid crystal layer whose helical pitch is continuously changed in the thickness direction thereof and thus admits only red light. Moreover, if the intensity of light that has undesirably passed through the filter layer 6 is suppressed to 20% or less of that of the incident light, there will be no practical problems even when such light reaches the bottom of the filter layer 6 and is reflected back as a returning beam, because this returning beams is again reflected by the filter layer 6 and its intensity in a reproduction beam is as small as 4% (20%×20%) or less of that of the reproduction beam.

### <Specific Example 2 of the Optical Recording Medium>

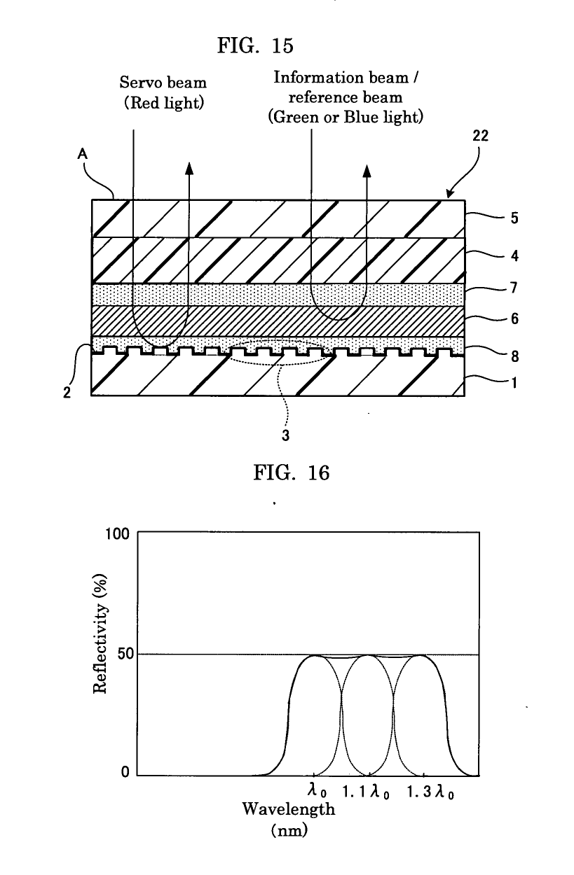

FIG. 15 is a schematic cross-sectional view showing the structure of the optical recording medium of specific example 3 in the present invention. This optical recording medium 21 according to specific example 3 is similar to that of Specific Example 1 except for the configuration of the filter layer 6.

In FIG. 15 the filter layer 6 admits only red light and reflects light of the other colors. Therefore, the information beam and reference beam for recording and reproduction do not pass through the filter layer 6 because they are light of green or blue, and never reach the reflective film 2, becoming returning beams emitting from the light entrance/exit surface A.

The filter layer 6 is a laminate of seven dielectric thin layers with different indices of refraction formed on a colored material-containing layer 6b. The filter layer 6, where the dielectric thin layers and a colored material-containing layer are combined, may be directly formed on the first gap layer 8 with a coating or deposition method, or may be formed by stamping a film, in which dielectric thin layers and a colored material-containing layer is formed on a base material, into the optical disc shape. Using such a filter layer leads to optical transmittance of 50% or more for light of wavelength 655 nm and 30% or more for light of wavelength 532 nm, both incident at an angle of within ±40°, thereby eliminating the fluctuations in the selectively-reflecting wavelength range even when the incident angle has changed.

The optical recording medium 22 of Specific Example 2 may be of disc shape or card-like shape, and is formed in the same way as the optical recording medium of Specific Example 1.

Note also that optical operations performed around the optical recording medium 22 in Specific Example 2 are similar to those in Specific Example 1.

### EXAMPLES

Hereinafter, Examples of the invention will be described, which however shall not be construed as limiting the invention thereto. Note also that “part(s)” means “part(s)” by mass” unless otherwise indicated.

### Example 1

### <Preparation of Optical Recording Medium>

The optical recording medium of Example 1 was prepared in the following way by depositing, in order, a recording layer, a second gap layer, a filter layer, a first gap layer, and a second substrate on a first substrate. The filter layer was formed by preparing a film-shaped filter and depositing it on the second gap layer.

### —Components in Photosensitive Composition Solution for Recording Layer—

A photosensitive composition made of the following components was stirred in a nitrogen flow to prepare a photosensitive composition solution.

| | |
|---|---|
| Biscyclohexylmethane diisocyanate | 31.5 Parts |
| Polypropyleneoxide triol (molecular weight = 1,000) | 61.2 Parts |
| Tetramethyleneglycol | 2.5 Parts |
| 2,4,6-Tribromophenyl acrylate | 3.1 Parts |
| Photoinitiator | 0.69 Parts |
| (IRGA CURE 784, produced by Ciba Specialty Chemicals) | |
| Dibutyl tin dilaurate | 1.01 Parts |

### Preparation of Filter

Initially, polyvinyl alcohol (bland name: MP 203, produced by Kuraray Co., Ltd.) was applied on a polycarbonate film of 100 μm thickness (bland name: Iupilon, produced by Mitsubishi Gas Chemical Company Inc.) to a thickness of 1 μm to prepare a base film. The surface of the polyvinyl alcohol film was rubbed by passing it through a rubbing device, thereby imparting liquid crystal alignment capability to the base film.

Next, coating solutions A, B, and C for cholesteric liquid crystal layer having the components shown in Table 1 below were prepared by a conventional method.

TABLE 1

Coating solution for cholesteric
liquid crystal layer

| Component (unit: part) | A | B | C |
|---|---|---|---|
| UV polymerizable | 93.16 | 94.02 | 94.74 |
| liquid crystal compound | | | |
| Chiral compound | 6.84 | 5.98 | 5.26 |
| Photoinitiator | 0.10 | 0.10 | 0.10 |
| Sensitizer | 0.02 | 0.02 | 0.02 |
| Solvent | 400 | 400 | 400 |

* UV polymerizable liquid crystal compound: PALIOCOLOR LC242 (bland name, produced by BASF Corp.)
* Chiral compound: PALIOCOLOR LC756 (bland name, produced by BASF Corp.)
* Photoinitiator: IRGACURE 369 (bland name, produced by Ciba Specialty Chemicals)
* Sensitizer: diethylthioxanthone
* Solvent: methyl ethyl ketone (MEK)

Next, the coating solution A for cholesteric liquid crystal layer was applied on the base film with a bar coater, dried, and allowed to stand at 110° C. for 20 seconds for alignment of liquid crystals. Thereafter, the resulting liquid crystal was exposed to light under 110° C. with an ultrahigh-pressure mercury vapor lamp at exposure dose of 500 mJ/cm² to form a cured film of 2 μm thickness as a cholesteric liquid crystal layer A.

Next, the coating solution B for cholesteric liquid crystal layer was applied on the cholesteric liquid crystal layer A with a bar coater, dried, and allowed to stand at 110° C. for 20 seconds for alignment of liquid crystals. Thereafter, the resulting liquid crystal was exposed to light under 110° C. with an ultrahigh-pressure mercury vapor lamp at an exposure dose of 500 mJ/cm² to form a cured film of 2 μm thickness as a cholesteric liquid crystal layer B.

Next, the coating solution C for cholesteric liquid crystal layer was applied on the cholesteric liquid crystal layer B with a bar coater, dried, and t allowed to stand at 110° C. for 20 seconds for alignment of liquid crystals. Thereafter, the resulting liquid crystal was exposed to light under 110° C. with an ultrahigh-pressure mercury vapor lamp at an exposure dose of 500 mJ/cm² to form a cured film of 2 μm thickness as a cholesteric liquid crystal layer C.

In this way, a three-layered filter for optical recording medium of Example 1 was prepared that has circularly polarizing characteristic, wherein each cholesteric liquid crystal layer has a different λ value and the helices rotate in the same, right-handed direction.

Next, the resultant filter for optical recording medium was stamped into a disc shape of predetermined size for arrangement the filter on the substrate.

### —First Substrate—

For the first substrate, a polycarbonate resin substrate of 120 mm diameter and 0.6 mm thickness was used, a substrate that is generally used for DVD+RW discs. The surface of the substrate used was smooth and free from any concavo-convex pattern such as a servo pit pattern.

One surface of the first substrate was coated with a dielectric multilayered film to form a reflective layer that has a reflectivity of 0.1% for a beam of light with a wavelength of 532 nm that is incident on its surface at right angle.

### —Second Substrate—

For the second substrate, a polycarbonate resin substrate of 120 mm diameter and 0.6 mm in thickness was used, a substrate that is generally used for DVD+RW discs. A servo pit pattern was formed all over the surface of the substrate, with the track pitch being 0.74 μm, the groove depth 175 nm, and groove width 300 nm. Further, a reflective film made of aluminum (Al) was deposited on the surface of the servo pit pattern of the second substrate to a thickness of 200 nm by DC magnetron sputtering, so that the reflective film has a reflectivity of 90% for a beam of light with a wavelength of 532 nm that is incident on its surface at right angle.

### —Outer Circumferential Spacer—

The outer circumferential spacer has a circular shape with a diameter of 120 mm, a value that is the same as those of the first and second substrates, has a width of 0.5 mm±100 μm in a surface direction, and has a thickness of 500 μm, a value that is equal to that of the first recording layer 4. Thus, the cross-sectional shape is quadrangle with a dimension of 0.5 mm×500 μm.

The outer circumferential spacer was prepared by injection molding of polycarbonate with excellent moldability and mechanical strength using an injection molding machine manufactured by Sumitomo Heavy Industries, Ltd.

### —Inner Circumferential Spacer—

As shown in FIG. 13, the inner circumferential spacer had a circular shape with a diameter of 15 mm, a value that is the same as the opening diameter of openings 5b and 1b of the first substrate 5 and second substrate 1, has a width of 0.5 mm±+100 μm in a surface direction, and a thickness of 500 μm, a value that is equal to that of the first recording layer 4. Thus, the cross-sectional shape is quadrangle with a dimension of 0.5 mm×500 μm as with the outer circumferential spacer.

The outer circumferential spacer was prepared by injection molding of polycarbonate with excellent moldability and mechanical strength, a polycarbonate identical to that used for the outer circumferential spacer, using an injection molding machine manufactured by Sumitomo Heavy Industries, Ltd.

### —Formation of Laminate—

As shown in FIG. 13, after applying an adhesive (SD-640, produced by Dainippon Ink and Chemicals Inc.) on the foregoing filter, the film was deposited on the second substrate 1 that had been coated with a first gap layer 8 by spin coating, while avoiding entry of air bubbles therein, and thereby a first filter layer 6 was formed. Then, a first gap layer 7 was bonded on the first filter layer 6 with a laminator (model name: HAL 110aa, produced by Sankyo Co., Ltd.) under the conditions of a pressure-roller temperature of 23° C., pressure-roller pressure of 0.1 MPa and bonding speed of 1.0 m/min.

Further, as shown in FIG. 18, the resulting outer circumferential spacer 37 was bonded to the surface of the first gap layer 7 so that the outer shape of the outer circumferential spacer 37 matched to that of the second substrate 1, and further an inner circumferential spacer 38 was bonded to the surface of the first gap layer 7 so that the center of the inner circumferential spacer is aligned to that of the second substrate 1. A UV adhesive (SD-640, produced by Dainippon Ink and Chemicals Inc.) was used as the adhesive and cured by irradiation with UV for bonding.

The resulting coating solution of composition for optical recording layer was poured into the groove with a depth of 500 μm that is defined by the outer circumferential spacer 37 and inner circumferential spacer 38.

The coating solution was poured under the conditions of a temperature of 23° C., a liquid viscosity of 300 mPas and a humidity of 50%.

Subsequently, the composition for optical recording layer was cured under the conditions of a temperature of 80° C. and for 40 minutes to thereby form a recording layer 4. The thickness of the recording layer 4 was 500 μm.

An adhesive (GM-9002, produced by Blenny Giken Ltd.) was applied over the recording layer 4, a first substrate 5 was arranged thereon, and the edges of the first and second substrates were pressurized at a pressure of 0.08 MPa at 80° C. for 40 minutes to form a laminate. The end surfaces of the first and second substrates were sealed with an moisture-curable adhesive and allowed to stand at 80° C. for 24 hours. In this way optical recording media that are identical to the optical recording medium 21 shown in FIGS. 12 and 14 were fabricated.

### —Recording on Optical Recording Media —

A recording test was conducted on one of the obtained optical recording media using a collinear hologram-disc tester (SHOT-2000, manufactured by Pulstec Industrial Co., Ltd.). In the test, 50-fold hologram multiplexing was conducted using a recording spot that is 200 μm in diameter measured at the focal position of the holograms to be recorded. Furthermore, a single hologram was recorded in the same way in another obtained optical recording medium using the tester.

In Example 1, the synchronization marks in the pattern of the beam passed thought the spatial light modulator were arranged in a dotted random pattern in both vertical and horizontal directions, as shown in FIG. 21.

### —Evaluation of Optical Recording Medium for Signal-to-Noise Ratio During Information Reproduction—

The above-stated tester was used for measuring the signal-to-noise ratio (SNR) of both the reconstructed image of the 50 recorded holograms and the reconstructed image of the recorded single hologram. The measurement results are given in Table 2. A Fourier-transformed image after 50-fold multiplexing is shown in FIG. 22.

### Examples 2 to 5

As in Example 1, 50-fold multiplexing recording and single-hologram recording were conducted on optical recording media prepared in the same manner as those of Example 1, with synchronization marks arranged in different patterns given in Table 2, followed by measurement of the SNR values for each recording medium as in Example 1. The measurement results are given in Table 2.

### Comparative Example 1

As in Example 1, 50-fold multiplexing recording and a single-hologram recording were conducted on optical recording media prepared in the same manner as those of Example 1, except that synchronization marks were arranged in a pattern given in Table 2 (i.e. a grid pattern like that shown in FIG. 19). And SNR values were measured for each recording medium as in Example 1. The measurement results are given in Table 2.

TABLE 2

| | Synchronization marks | | | | |
|---|---|---|---|---|---|
| | | | Fourier | SNR measured upon | SNR measured upon |
| | | Arrangement | transformed | reproduction of single- | reproduction of |
| | Form | pattern | image | hologram | multiplexed-holograms |
| Ex. 1 | Random | Randomly-spaced | FIG. 22 | 4.6 | 3.2 |
| | | pattern | | | |
| | | (FIG. 21) | | | |
| Ex. 2 | Solid | Cross pattern | FIG. 24 | 4.4 | 2.5 |
| | line | (FIG. 23) | | | |
| Ex. 3 | Solid line | Circumference of | FIG. 28 | 4.5 | 2.6 |
| | | data area | | | |
| | | (FIG. 27) | | | |
| Ex. 4 | Dotted | Cross pattern | FIG. 26 | 4.6 | 2.8 |
| | line | (FIG. 25) | | | |
| Ex. 5 | Dotted | Circumference of | FIG. 30 | 4.8 | 3.0 |
| | line | data area | | | |
| | | (FIG. 29) | | | |
| Compara. | Grid | Regularly-spaced | FIG. 20 | 4.5 | 1.8 |
| Ex. 1 | | pattern | | | |
| | | (FIG. 19) | | | |

It can be established from the result shown in Table 2 that, while the SNR values for the reconstructed single-hologram images were almost the same among Examples 1 to 5 and Comparative Example 1, it resulted in higher effect of preventing reduction in the SNR values for the reconstructed 50-fold multiplexing hologram images in Examples 1 to 5 as opposed to Comparative Example 1.

The optical recording method of the present invention can provide an adequate exposure dose for fixing that is adjusted to an exposure dose for recording during shift-multiplexing recording and thus can prevent an excessive fixing exposure while providing sufficient degree of fixing, is an excellent recording method to prevent sensitivity reduction in the unrecorded areas caused by being exposed to the fixing exposure, and can preferably be used for a recording method for a high-density optical recording medium. The optical recording method of the present invention can also preferably be used for recording of plane holograms in which two-dimensional image data are recorded in a relatively thin recording medium and volume holograms in which high-volume data like three-dimensional image data are recorded, and as a transmissive optical recording method and a reflective optical recording method. Furthermore, the optical recording method of the present invention can be widely used for recording of various kinds of holograms including amplitude holograms, phase holograms, blazed holograms, and complex amplitude holograms.

The optical recording apparatus of the present invention can also provide an adequate exposure dose for fixing that is adjusted to an exposure dose for recording during shift-multiplexing recording and thus can prevent an excessive fixing exposure while providing sufficient degree of fixing, is an excellent recording method to prevent sensitivity reduction in the unrecorded areas caused by being exposed to the fixing exposure, and can preferably be used for a recording apparatus for high-density optical recording media. The optical recording apparatus of the present invention can also preferably be used for recording of plane holograms in which two-dimensional image data are recorded in a relatively thin recording medium and volume holograms in which high-volume data like three-dimensional image data are recorded, and as a transmissive optical recording apparatus and a reflective optical recording apparatus. Furthermore, the optical recording apparatus can be widely used for recording of various kinds of holograms including amplitude holograms, phase holograms, blazed holograms, and complex amplitude holograms.

The optical recording medium of the present invention can record information therein with the optical recording method of the present invention, and is provided with an adequate exposure dose for fixing that is adjusted to an exposure dose for recording in shift-multiplexing recording while an excessive fixing exposure is prevented and sufficient degree of fixing is provided and thus is an excellent recording medium that can prevent sensitivity reduction in the unrecorded areas caused by being exposed to the fixing exposure. Therefore, the optical recording medium of the present invention can also preferably be used for recording of plane holograms in which two-dimensional data are recorded onto a relatively thin recording medium and volume holograms in which high-volume data like three-dimensional image data are recorded, and as a transmissive optical recording medium and a reflective optical recording medium. Furthermore, the optical recording medium can be widely used for recording of various kinds of holograms including amplitude holograms, phase holograms, blazed holograms, and complex amplitude holograms.

What is claimed is:

1. An optical recording method comprising:
applying an information beam and a reference beam onto an optical recording medium to record information therein, the optical recording medium having a recording layer for recording the information by holography,
wherein at least the information beam is passed through a spatial light modulator and is formed as a two-dimensional pattern that is composed of a data area and a plurality of synchronization marks for detecting information concerning the positions of data recorded in the data area, and
wherein the synchronization marks are arranged in a random pattern so that in a Fourier-transformed image of the two-dimensional pattern, light intensities derived from the synchronization marks are lower than light intensities in a Fourier-transformed image of a two-dimensional pattern composed of a data area and a plurality of synchronization marks arranged in a grid pattern, the light intensities being derived from the synchronization marks arranged in a grid pattern.

2. The optical recording method according to claim 1, wherein the synchronization marks arranged in a random pattern are present in two or more different forms.

3. The optical recording method according to claim 1, wherein the synchronization marks arranged in a random pattern are randomly arranged both in vertical and horizontal directions.

4. The optical recording method according to claim 1, wherein the synchronization marks are arranged in a cross consisting of a vertical line and a horizontal line, and at least one of the vertical line and horizontal line is a straight line or curve.

5. The optical recording method according to claim 1, wherein the synchronization marks are arranged at the entire circumference of the two-dimensional data area, the synchronization marks being arranged in a straight line or curve.

6. The optical recording method according to claim 4, wherein the straight line or curve constituting the synchronization marks is a solid line or solid curve.

7. The optical recording method according to claim 4, wherein the straight line or curve constituting the synchronization marks is a dotted line or dotted curve.

8. The optical recording method according to claim 7, wherein the interval between the adjacent synchronization marks in the dotted line or dotted curve is an integer multiple of a minimum pixel interval of the spatial light modulator.

9. The optical recording method according to claim 1, wherein recording of information performed by application of the information beam and reference beam is performed with shift-mutiplexing recording.

10. The optical recording method according to claim 1, wherein the information beam and reference beam are applied in such a way that the optical axis of the information beam is collinear with the optical axis of the reference beam.

11. The optical recording method according to claim 1, wherein the optical recording medium comprises, in order, a first substrate, the recording layer, a filter layer, and a second substrate.

12. The optical recording method according to claim 1, wherein the optical recording medium records therein a reflective hologram.

13. An optical recording apparatus comprising:
a laser light source for emitting an information beam and a reference beam onto an optical recording medium to record information therein, the optical recording medium having a recording layer for recording the information by holography; and
a spatial light modulator through which at least one of the information beam and reference beam passes,
wherein the information beam passed through the spatial light modulator is formed as a two-dimensional pattern that is composed of a data area and a plurality of synchronization marks for detecting information concerning the positions of data recorded in the data area, and
wherein the synchronization marks are arranged in a random pattern so that in a Fourier-transformed image of the two-dimensional pattern, light intensities derived from the synchronization marks are lower than light intensities in a Fourier-transformed image of a two-dimensional pattern composed of a data area and a plurality of synchronization marks arranged in a grid pattern, the light intensities being derived from the synchronization marks arranged in a grid pattern.

14. An optical recording medium comprising:
a hologram recorded by an optical recording method which comprises:
applying an information beam and a reference beam onto the optical recording medium to record information therein, the optical recording medium having a recording layer for recording the information by holography,
wherein at least the information beam is passed through a spatial light modulator and is formed as a two-dimensional pattern that is composed of a data area and a plurality of synchronization marks for detecting information concerning the positions of data recorded in the data area, and
wherein the synchronization marks are arranged in a random pattern so that in a Fourier-transformed image of the two-dimensional pattern, light intensities derived from the synchronization marks are lower than light intensities in a Fourier-transformed image of a two-dimensional pattern composed of a data area and a plurality of synchronization marks arranged in a grid pattern, the light intensities being derived from the synchronization marks arranged in a grid pattern.
